(19) United States
(12) Patent Application Publication
(10) Pub. No.: US 2016/0133143 A1
(43) Pub. Date: May 12, 2016

(54) Internet System for Self-Empowerment

(71) Applicants: Richard J. Blue, Carlsbad, CA (US); Jennifer M. Patterson, Carlsbad, CA (US)

(72) Inventors: Richard J. Blue, Carlsbad, CA (US); Jennifer M. Patterson, Carlsbad, CA (US)

(21) Appl. No.: 14/121,984

(22) Filed: Nov. 10, 2014

(51) Int. Cl. G09B 7/00; G09B 5/00

(52) U.S. Cl. CPC G09B 7/00; G09B 5/00

(57) ABSTRACT

A system permitting a company to utilize the Internet to provide tools individuals will use to support their self-empowerment and to provide private monitoring of performance of the students by a plurality of mentors and a limited number of third parties selected by the students, In preferred embodiments the system includes a number of secure private Internet systems, one for each student, with each system limited to a studio administrator, the student, his teacher/mentor, and a limited number (preferably less than 25) of designated third parties such as family members and friends of the student.

### CROSS REFERENCE TO RELATED APPLICATIONS

The present invention is a continuation-in-part of Ser. No. 13/253,966 filed Oct. 6, 2011.

### FIELD OF THE INVENTION

The present invention relates to methods of tracking development of people in a variety of aspects of their lives and in particular techniques for using the Internet to document their progress with the aid of a small, private, and invited group of people who support and mentor them.

### BACKGROUND OF THE INVENTION

### To Get the Most Out of Life

From birth to death each of us is continuously faced with challenges, opportunities and decisions to make. Our success in every aspect of our lives depends mostly on how well we deal with these challenges, opportunities and the decisions we make in response to these challenges and opportunities. We can generally divide up our lives into three generally categories: our schooling, our work and everything else.
1. School (Scholastic Studies)
   Our schooling includes:
      i. Pre-schooling, including learning to walk, talk and getting along with others
      ii. Schooling, including formal and informal education from elementary school to as far as we go in our formal education. This for some of us will be limited and for some of us will include college and graduate school.
      iii. Continuing education, however all of us will continue to learn throughout our lives.
2. The Arts
   The arts include all other aspects of our lives other than scholastic studies and work. These are generally the things that we are interested in, that we want to do and be good at which provide a variety of rewards, mostly life skills and for a few financial rewards. These include musical arts (the example used throughout this submission), dance, culinary, literary and performance.

### How Organized Are We?

In all of the aspects of our lives most of us generally react to our challenges and opportunities without much thought as to our specific and long-term goals. Our schools provide more or less standard education generally without regard to the specific goals of the student. In fact most students do not have specific goals in life except maybe to get good grades in their assigned classes. The methods of teaching students have remained similar throughout history. An instructor usually conducts lessons with a student, monitors his progress, verifies his development and offers encouragement and increasing challenges to further develop his skills. This method has worked tremendously well throughout history with many students, particularly those with the support and encouragement of family, friends and a social network. However, there are many students who also get lost along the way. For example, the most common thought for millions of people alive today, who took arts lessons as children, is “I wish I hadn't given up music lessons.” For many there is an accompanying thought, “I wish my parents hadn't let me to stop.” The average American who takes arts lessons quits after 8 months. Perhaps many feel they do not get enough attention or positive reinforcement and decide to give up their instrument prematurely.

Modern technology is changing the world at an amazing pace. The personal computer is a fixture in most middle class homes in modern society. It is now possible for individuals to have instant access to inexpensive communication and information in ways never thought possible just two decades ago.

### The Internet and Intranets

The Internet is a large network of interconnected computers that is sometimes referred to as a Wide Area Network (WAN). Initially developed by the United States Defense Department, it has expanded worldwide to a great variety of uses. A significant percentage of the population in the United States and in many other countries currently has access to the Internet and its use is growing rapidly.

The Internet is used to advertise products. Many companies have WEB sites and encourage potential customers to “visit” these pages. Creation of WEB sites is a well-developed Internet business with a great many people and organizations offering to create WEB sites. Some WEB sites are static, i.e. there is no interaction between the user and the WEB site. However, there are many well-known techniques that permit the WEB site to be made active. These techniques permit an Internet server to change WEB pages as often as desired and they permit users to communicate with a processor associated with the WEB site.

The technology also exists to establish a Local Area Network (LAN). A LAN is a network of interconnected workstations sharing the resources of a single processor or server within a relatively small geographic area. Typically, this might be within the area of a small office building. A suite of application programs can be kept on the LAN server. Users who frequently need an application can download it once and then run it from their local hard disk.

An Intranet is a network connecting an affiliated set of users (usually limited to a specific community of interest) using standard Internet protocols, esp. TCP/IP and HTTP. Intranets, also known as internal Webs, are only logically “internal” to an organization. Physically they can span the globe, as long as access is limited to the defined community of interest. To draw a comparison, the World Wide Web comprises all HTTP nodes on the public Internet. An internal web may comprise all HTTP nodes on a private network, such as an organization's LAN or WAN. If the organization is a corporation, the internal web is also a corporate web.

### SUMMARY OF THE INVENTION

The present invention provides a method of utilizing the Internet to connect invited family, friends, mentors (such as teachers) to students. As explained above this application is a continuation-in-part of patent application Ser. No. 13/253,966 which is incorporated herein by reference. This application is to be issued as U.S. Pat. No. 8,884,146 on Nov. 11, 2014. That application was directed at music students and their performance and providing through the Internet a system to permit the monitoring of their performance by their music teachers and a limited number of third parties selected by the students. The concepts of that patent application are in this application extended beyond music to other art forms and to scholastic performance by students. Much of the description provided in the parent application has been incorporated herein as a particular embodiment of the present invention. In embodiment of the present invention the role of the music teacher is replaced by a mentor which in the case of music students would be a music teacher.

In preferred embodiments the method includes the creation of a number of secure private Internet systems, one for each student, with each system limited to a studio administrator, the student, his teacher/mentor, and a limited number (preferably less than 25) of designated third parties such as family members friends and teachers of the student.

In preferred embodiments a server computer is programmed with software that permits private secure communication between mentors and their clients or students. Software is provided that permits mentors and their clients or students to upload encrypted client or student performances to a server operated by the. In preferred embodiments the uploaded performances are stored in a file referred to as the Journal's Dashboard, and identified to each particular client or student. The software is designed to permit the mentor to limit access to the performances to a limited number of persons who have agreed to prevent access to the performances by members of the general public. In preferred embodiments the software permits access to only ten computers as designated by the client or students or their mentors. An administrator has control of the server and is obligated to take down any performance in accordance with the requirements of the DMCA that he is made aware of that violates any copyright. It is the purpose of the present invention to provide a method by which an administrator can utilize the Internet to permit students to allow in private to their friends and family to view and listen to and comment on their performances, lessons and practice session. The procedures of this invention are carefully prepared to assure that all performances by the client or student are private (not public) performance and to assure that any copying of the performed art work is permitted as fair use of the copyright which is not an infringement of the copyright.

The Journal enables a person to select significant venue and to not lose track of the facts that will support a sense of empowerment. The general format is focused on the person keeping the Journal (i.e. the Journaler). It is not intended to be a general give and take between people; it is a conversation, written or verbal, with a purpose, the empowerment of the Journaler. The goal is to gather measurable, observerable and demonstrable facts that can be used by the Journaler in representing who they are and what they do.

The present invention provides a structure for clients and students to empower their lives. The structure is outlined below and explained in detail in the detailed description;

The Structure
a. Provide tools to
   i. Post events
   ii. Organize Post
   iii. Define the level of privacy
      1. Journal—Only available to the Journaler
      2. Portfolio—Only available to their small, invited group of invited Family/Friends, Teacher/mentor(s) and Mentors(s).
   iv. Get feedback
   v. Store video, audio and written comments
   vi. Use to support their self-expression
b. Relate successes to skill development
   i. Arts—focused doing skills
   ii. School—focused on cognitive skills
   iii. Work—focused on doing and cognitive skills
c. Create a safe and lawful space
   i. Protects the Journaler from being connected to anyone who is not in the small, invited group of supporters.
   ii. Protects the rights of others from infringement of their copyrights.
   iii. A secure Journal Sharing, in the sense of letting someone see and/or listen to only some of the posts in the Journal located on their Portfolio.

An administrator computer controlled by the administrator also communicates with the server computer. The administrator computer is programmed to permit an administrator to coordinate communication in private among the teacher/mentor, the student and a limited number (such as ten) of selected third parties. This communication is through a secure private “virtual intranet” via computers under the control of the mentor, computers under the control of the client or student and computers under the control of a limited number (such as ten) of selected third parties. These third parties are typically family members and friends, teacher/mentors and mentors. Performances can be downloaded to the identified computers, but special software prevents the copying of the downloaded performances. These computers are programmed for transmitting and receiving information related to the learning process of the arts student. Preferably, the information related to the learning process of the client or student includes recorded video and/or audio performances by the student (including video and/or audio performances of copyrighted works), photos and praise, criticism, suggestions and comments by the teacher/mentor and mentor the limited number of third parties.

In preferred embodiments access to this system is expected to be at very low cost to the students, such as about $10 per month. In these preferred embodiments the student or his or her parents select the mentor and is responsible for any fees charged for the mentoring. However, the studio may provide lists of mentors covering any of the arts or scholastic studies. In other embodiments the studio could make arrangements to provide the mentors, but in those situations the fees could be much higher.

In preferred embodiments the administrator is responsible for assuring that all activities carried out through the private Intranets is in full compliance with the United States Copyright Law. Specifically, sheet arts of copyrighted works used by the teacher/mentor should be purchased from authorized publishing houses unless an exception is clearly authorized by the copyright law. The student and all third parties making use of the Internet must be informed of their obligations under the copyright law. The administrator also has the obligation to comply with the requirements of the DMCA so as to avoid any liability for damages when informed of a copyright infringement in connection with one of the Intranets.

Works that are in the public domain are not covered by copyright and may be made available to the general public, in which case any fees collected may be divided between the studio and the student and/or his teacher/mentor.

### BRIEF DESCRIPTION OF THE DRAWINGS

FIG. 1 shows a preferred home page.

FIGS. 2-3 show a preferred log on page.

FIG. 4 shows a preferred personal profile page.

FIG. 5 shows a preferred personal home page.

FIG. 6 shows a preferred page for adding a post.

FIG. 7 shows a preferred video page.

FIG. 8 shows a preferred audio page.

FIG. 9 shows a preferred pictures page.

FIG. 10 shows a preferred audio accomplishments page.

FIGS. 11-12 show another preferred audio accomplishments page.

FIG. 13 shows a preferred teacher/mentor comments page.

FIG. 14 shows a preferred teacher/mentor home page.

FIGS. 15-16 show a preferred registration page.

FIG. 17 shows a preferred administrator page.

FIG. 18 shows a preferred embodiment of the present invention.

FIG. 19 shows another preferred embodiment of the present invention.

FIG. 20 shows another preferred embodiment of the present invention.

FIG. 21 shows another preferred embodiment of the present invention.

FIGS. 22-32 show other specific features of a preferred embodiment of the present invention.

FIGS. 33A-33H are charts which will be utilized by Life Empowerment, Inc. to provide life empowerment to its clients and students.

### DETAILED DESCRIPTION OF THE PREFERRED EMBODIMENTS

### First Preferred Embodiment

### Life Empowerment Structure

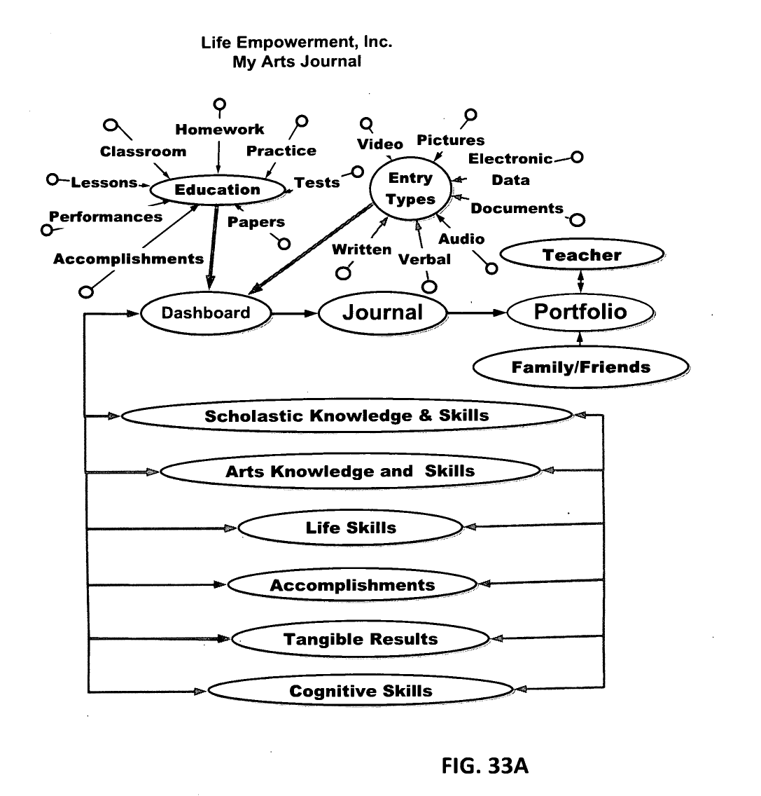

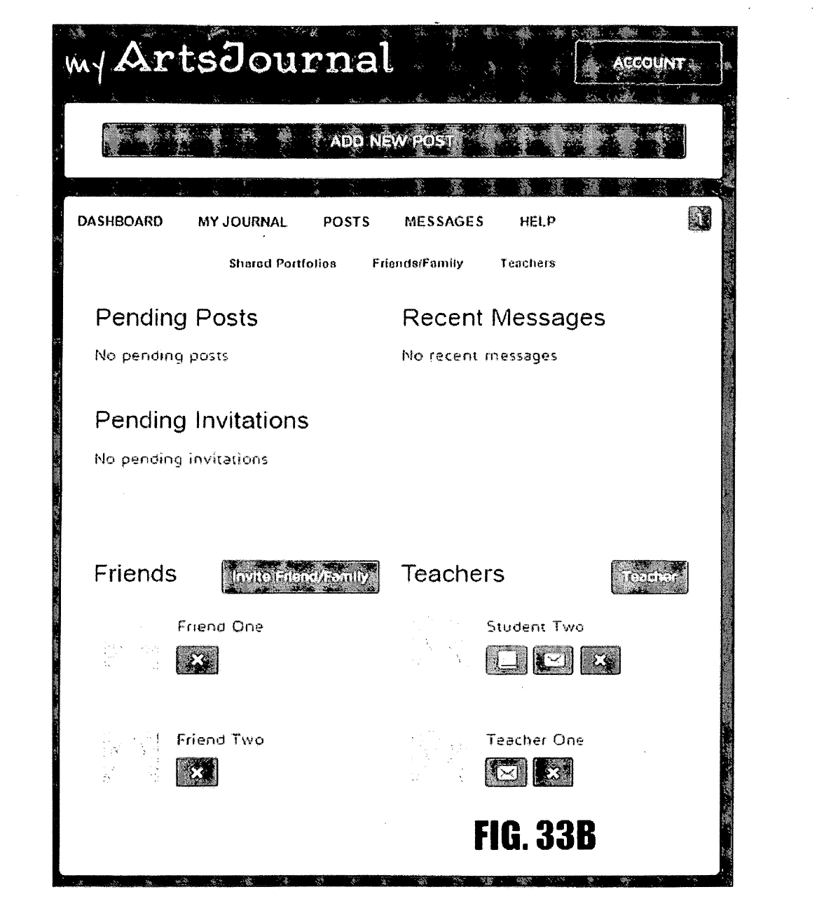

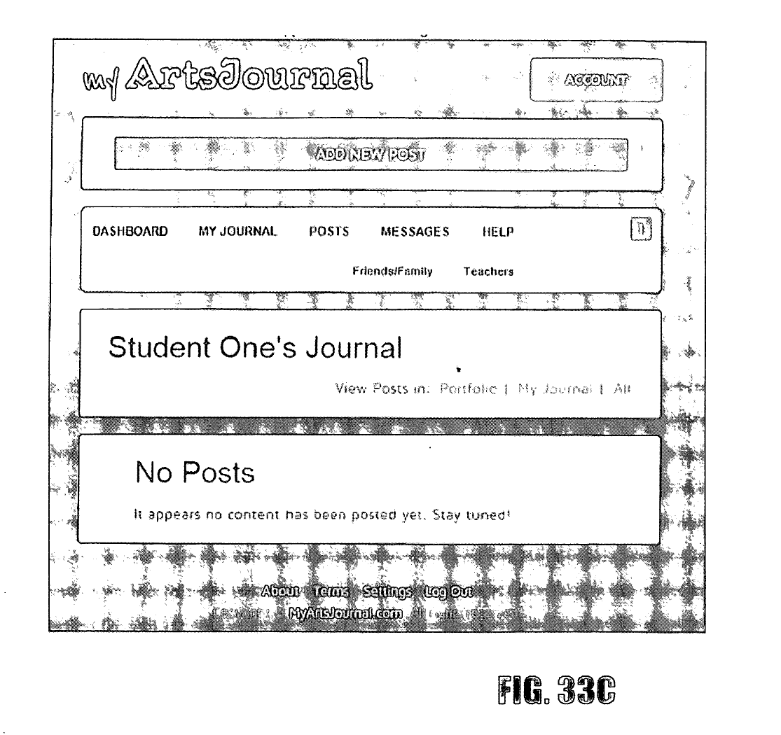

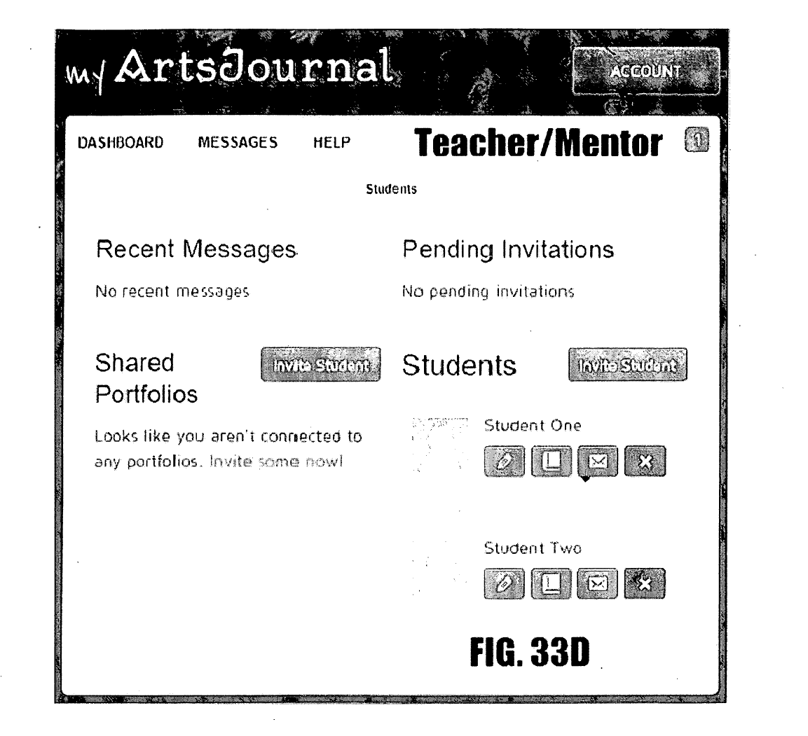

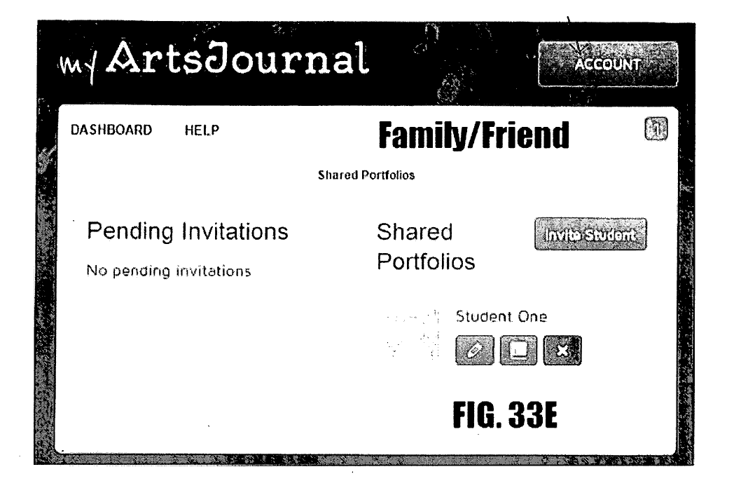

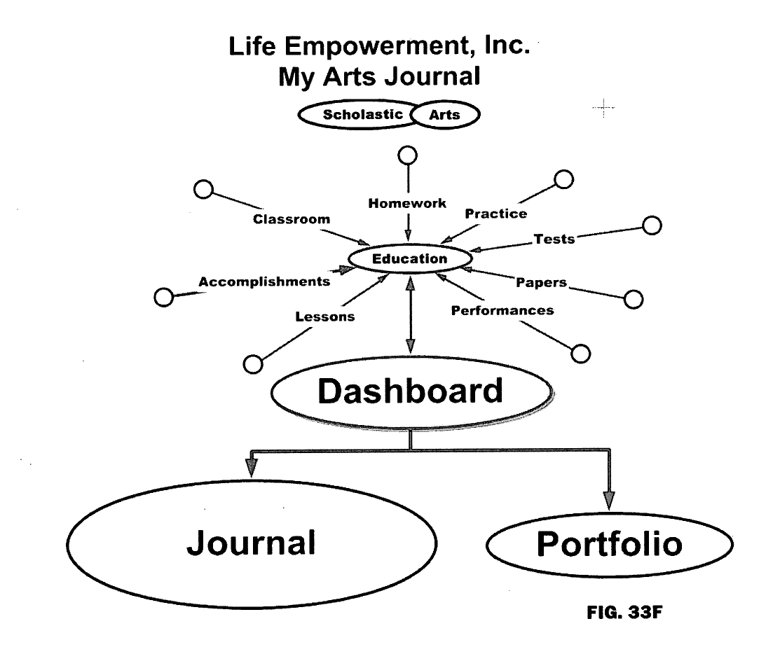

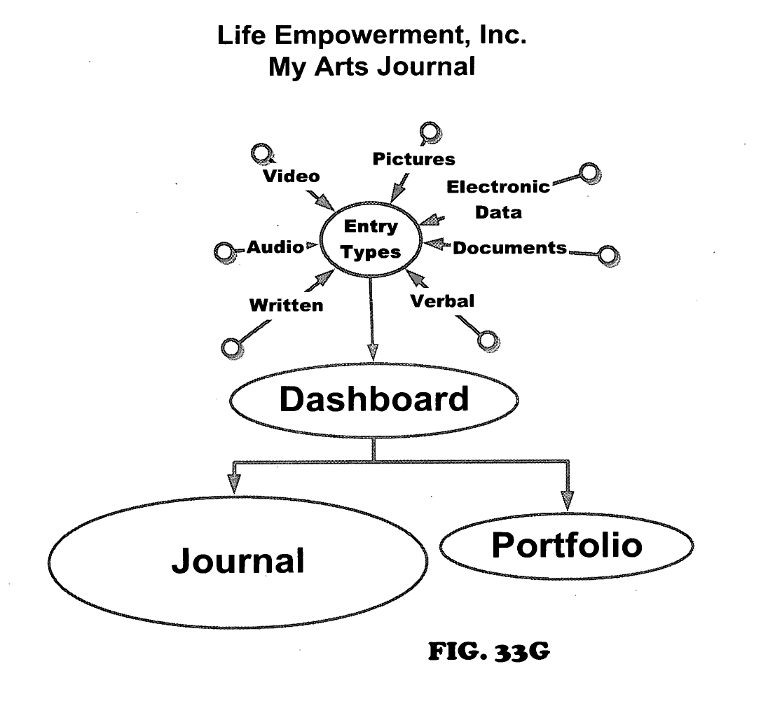

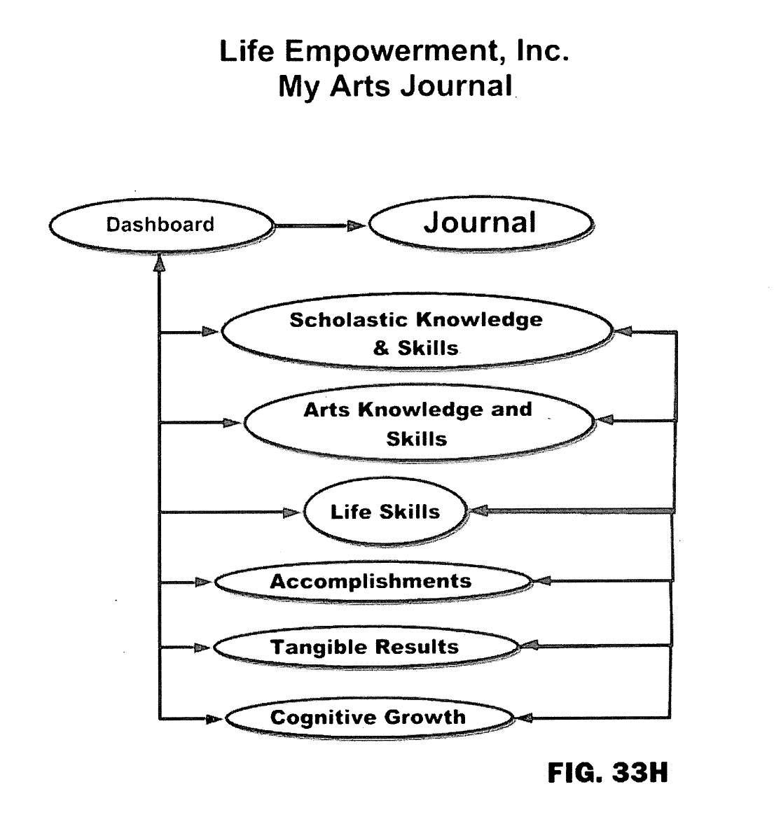

FIGS. 33A-33H are charts which will be utilized by Life Empowerment, Inc. to provide life empowerment to its clients and students. The basic structure of this preferred embodiment is provide tools to post events, organize post define the level of privacy. A Journal is available only to the Journaler. And a Portfolio is available only to their small, invited group of invited Family/Friends and Teacher/mentor(s). The structure allows the client to get feedback, store video, audio and written comments and to use to support their self-expression. The structure permits the Client to relate successes to skill development. The skill developments are focused differently for the arts and school:
i. Arts—focused doing skills,
ii. School—focused on cognitive skills, and

The Journaler Creates a Safe and Lawful Space that:
i. Protects the Journaler from being connected to anyone who is not in the small, invited group of supporters.
ii. Protects the rights of others from infringement of their copyrights.
iii. Provides a secure Journal Sharing, in the sense of letting someone see and/or listen to only some of the posts in the Journal located on their Portfolio.

The Key Goals of this Submission are—
1. Expand the use of the My Arts Journal to all the Arts and not just Music
2. To connect it to all learning activities
3. To expand the teacher to Teacher/Mentor

The Ultimate Goals of the Invention are—
1. To provide tools to support and track a person in their Scholastic and Arts endeavors
2. To provide Mentors with tools that supports the mentoring process
3. To define, track and use information which is the source of self-empowerment

The result is self-empowerment. To be self-empowered requires the development of both knowing and doing skills, the development of life skills and to track development with tangible results that support the development of both. Empowerment is built on information, information that tracks and asserts, to the individual, their power. Power is self-assertion of skills and abilities supported by facts and data.

My Arts Journal is used for all the Arts—music, dance, literary, martial, culinary, performance. It is also to be used to track development in scholastic settings—schools, colleges, vocational, extension and lifelong learning. Most classroom education today focuses on cognitive learning. It is about 90% knowledge skills, knowing facts and being able to retrieve them when needed, (i.e. pass a test, and write papers) and 10% arts skills, knowing how to take information and concepts the do something with them. Arts training focus on producing tangible results. It is about 90% application skills and 10% knowledge skills. The basic goal of arts education is to train students to do something with their knowledge: for example, read a piece of sheet music and play it.

Education for centuries has been scholastic and arts development. The arts are less and less a part of the education program. It has been diminishing more and more overs the past 50 years. As a result, employers are discovering that the new people into the work force are less and less skilled at putting knowledge onto practice.

### Life Empowerment Overview

FIG. 33A represents an over view of the life empowerment concept. It displays the primary elements needed to be self-empowered. These are as shown in the drawing:

1. The Journal
2. The Portfolio—a subset of the Journal accessible by a small, private support structure of Family/Friends and Teachers/Mentors
3. The sources and activities of measurable information/data and the types of entries
4. The various forms by which entries are made
5. The Categories used to organize the data

The Journal is a secure online repository for gathering and sharing facts/data that the individual will use to express his/her skills, abilities and accomplishments. The individual has control over: what goes into the journal, what stays in the journal, who sees it and what they see. Potential inputs to the Journal are displayed at the top of FIG. 33A. As FIG. 33A indicates that the Journal includes a Portfolio that is made available to Family/Friends and Teachers and Mentors via the Internet as will be explained in more detail later. The Journal provides easy access through all forms of Internet conductivity and is structured to make inactive communication and media to and from the Journal safe and easy. There are several elements of the Journal.

### The Dashboard

Everything enters My Arts Journal through the Dashboard as shown in FIG. 33A. the Dashboard is where Invitations are sent to Family/Friends and Teachers/Mentors. FIG. 33B shows who is connected, all Pending Posts, Recent Messages, Pending Invitations and all current Family/Friends and Teachers and other Mentors. FIG. 33B shows a computer screen in preferred embodiment explaining the type of information that is in the Dashboard. FIG. 33C shows a computer screen is the Student's Journal In this screen the student is identified as “Student One”.

### The Journal and Portfolio

The Journal is the repository for all postings to My Arts Journal once they have been accepted and assign to Journal or the Portfolio on the Dashboard. Invitations are provided to Family/Friends and Teachers/Mentors to connect to the Portfolio. The Portfolio is that portion of the Journal that the student makes available to a small (up to 25) group invited Family/Friends and Teachers/Mentors which provides for communication and support. This small group will provide support and encouragement. The link does not extend beyond this one person. Members of this support group can see and comment only on items in the Portfolio. Family/Friends and Teachers/Mentors invitations are most frequently sent from the Dashboard. The Dashboard also shows the Family/Friends and Teacher/Mentors currently connected to the Portfolio and those in process.

### Teacher/Mentor Account

FIG. 33D Show the Teacher/Mentor account page. A Teacher/Mentor can add a post, view the Student's Portfolio, send a message and remove the Student The Teacher/Mentor can also invite Students to connect to the teacher's account. This connection is designed to facilitate and enhance the communications between students and Teachers/Mentors for the purposes of heightening the Student's learning and skill.

### Family/Friends Account

The Family/Friends Account as shown in FIG. 33E can add a post with comments, view the Student's Portfolio and comment and remove the Student. This connection is designed to enable Family/Friends to provide support and positive feedback as the Student becomes more and more proficient. This support is critical to the Student's success in this endeavor.

FIG. 33F shows the sources and the categories of the postings to the Dashboard. They come from both School and Arts venues and kind of categories are Lessons, Accomplishments, Classroom, Homework, Practices, Tests, Papers and Performances.

FIG. 33G represents the kind of things that are tracked from both Scholastic and Arts activities.
1. As shown in FIG. 33G the Posts may be—
   Verbal, as in an audio or video message left after seeing a Student's recent accomplishment on The Student's Portfolio
   Written, as in a note typed into the Student's Journal
2. The Posts will be in one of several formats
   Audio
   Video
   Pictures
   Electronic Data
   Documents that have been scanned and posted
3. It can show the progress, such as, videos taken in a lesson by a Teacher showing an accomplishment in process and a final video showing when the Student has fully mastered the artistic objective. The same thing can be done in any classroom. Both the progress and accomplishment in Scholastic setting is more likely to be in a written form. These are all activities that have measured progress and accomplishments. They will be tracked in the Journal.

FIG. 33H shows the categories of measurable facts that are accumulated in the Journal. They are used to support accomplishment, knowledge and skills.
1. Scholastic Knowledge & Skills
   a. Scholastic Knowledge
   b. Skills associated with Scholastic Accomplishments
2. Arts Knowledge and Skills
   a. Arts Knowledge
   b. Skills associated with Arts Accomplishments
3. Life Skills (also known as Transferable Skills)
4. Accomplishments
5. Tangible Results
6. Cognitive—
   The thought and reasoning power gained through the combined knowledge and use of Scholastic, Arts and Life Skills and the associated accomplishments.

### Second Preferred Embodiment

### Internet System for Private Monitoring of Arts Students

A second preferred embodiment utilizes the present invention to provide a method of utilizing the Internet to permit arts teacher/mentors and/or mentors to document the progress of their arts students on their journal and which the student may make available to family and friends of the student without infringing the copyright of the owners of the arts that the students are learning. In order to avoid copyright infringement the method assures that all performances of the copyrighted works be made in private and not displayed publicly. In a preferred embodiment the method includes the creation of a number of secure private Internet systems, one for each student, with each Internet system limited to a studio administrator, the student, his teacher/mentor, his mentor and a limited number (preferably less than 25) of designated third parties such as family members and friends of the student.

### Private Performances

In preferred embodiments a server computer is programmed with software that permits private secure communication between a arts studio or school, teacher/mentors and their students. Software is provided that permits arts teacher/mentors and their students to upload encrypted student performances (including performances of copyrighted arts works) to a server operated by the arts studio. In preferred embodiments the uploaded performances are stored in a file referred to as the students' Journal, and identified to each particular student. The software is designed to permit the teacher/mentor and the student to limit access to the students to a limited number of persons who have agreed to protect access to the file by members of the general public. In preferred embodiments the software permits access to only 25 computers as designated by the students or their teacher/mentors. The studio has control of the server and is obligated to take down any performance in accordance with the requirements of the DMCA that he is made aware of that violates any copyright.

An administrator computer controlled by the studio is also connected to the server computer. The administrator computer is programmed to permit an administrator to coordinate communication in private among the teacher/mentor and/or mentor, the student and a limited number (such as twenty-five) of selected third parties. This communication is through a secure private “virtual intranet” via computers under the control of the teacher/mentor, computers under the control of the arts student (or his family) and computers under the control of a limited number (such as ten) of selected third parties. These third parties are typically family members and friends of the student or the student's family. Performances can be downloaded to the identified computers, but special software prevents the copying of the downloaded performances. These computers are programmed for transmitting and receiving arts information related to the learning process of the arts student. Preferably, the arts information related to the learning process of the arts student includes recorded video and/or audio performances by the student (including video and/or audio performances of copyrighted works), photos and praise, criticism, suggestions and comments by the teacher/mentor and the limited number of third parties.

The administrator is responsible for assuring that all activities carried out through the private Intranets is in full compliance with the United States Copyright Law. Specifically, sheet arts of copyrighted works used by the teacher/mentor should be purchased from authorized publishing houses unless an exception is clearly authorized by the copyright law. The student and all third parties making use of the Intranet must be informed of their obligations under the copyright law. The administrator also has the obligation to comply with the requirements of the DMCA so as to avoid any liability for damages when informed of a copyright infringement in connection with one of the Intranets. In preferred embodiment the administrator is registered with the United States Copyright Office as the Interim Designated Agent to receive notification of any claimed infringement of any copyrights. In the event of any claim the administrator must respond expeditiously to remove, or disable access to, the material that is claimed to, be infringing or to be the subject of infringing activity.

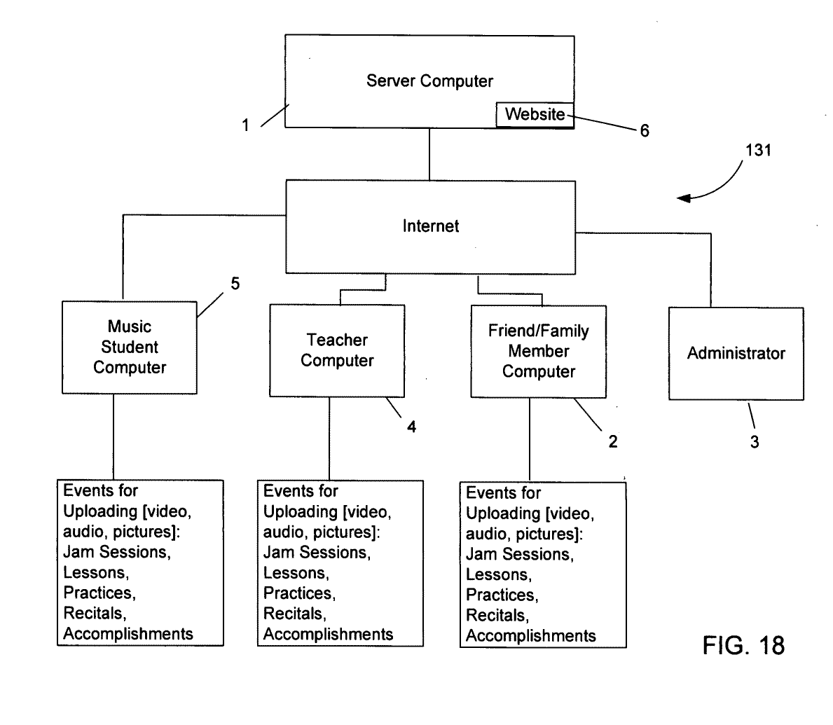

FIG. 18 shows a preferred embodiment of the present invention. The system shown in FIG. 18 allows for the storing, organizing, sharing and tracking of the arts learning process of the arts student. As the system is utilized, the student is given positive reinforcement by those closest to him and gains incentive to conquer innate challenges inherent in mastering any arts form. Server computer 1 is programmed to facilitate safe and secure communication between the arts student and those who have been approved to monitor his progress. It is one principle of the present invention that by communication with approved network members, the student will receive positive reinforcement and be continuously motivated to practice, study, perform, and learn arts.

Website 6 is a student monitoring web site of an arts studio practicing a preferred embodiment of the present invention. Website 6 is programmed onto server computer 1. Arts student computer 5, teacher/mentor computer 4, administrator computer 3 and friend/family member computer 2 are each connected to server computer 6 via the Internet. In a preferred embodiment of the present invention, a arts student, a arts teacher/mentor and friends and family of the arts student each are registered members of website 6. The arts student is able to upload arts events (for example, arts performances, arts practice sessions, and arts jam sessions) onto website 6. The arts teacher/mentor is able to review the student uploads and make comments and suggestions. The arts teacher/mentor is also able to upload arts related events onto website 6. Friends and family members likewise are able to review the student uploads and make comments and upload arts related events onto website 6. In this fashion, the arts student receives constant positive reinforcement from his arts teacher/mentor and those who are closest to him. A record is kept of his arts growth so it is very easy to see progression. These features are motivating and rewarding to the student and the student is more likely to continue to want to learn his instrument.

### Examples of Usage of the Website

In a preferred embodiment as shown in FIG. 18, website 6 is programmed onto server computer 1. Arts student computer 5 is connected to server computer 1 via the Internet. It is understood that students who are adults or older teenagers will likely operate student computer 5 themselves. However, younger children who are arts students will preferably have a parent or legal guardian controlling student computer 5 on behalf of the arts student. Therefore, for the purpose of this description it should be understood that a student refers to either the student himself or his guardian.

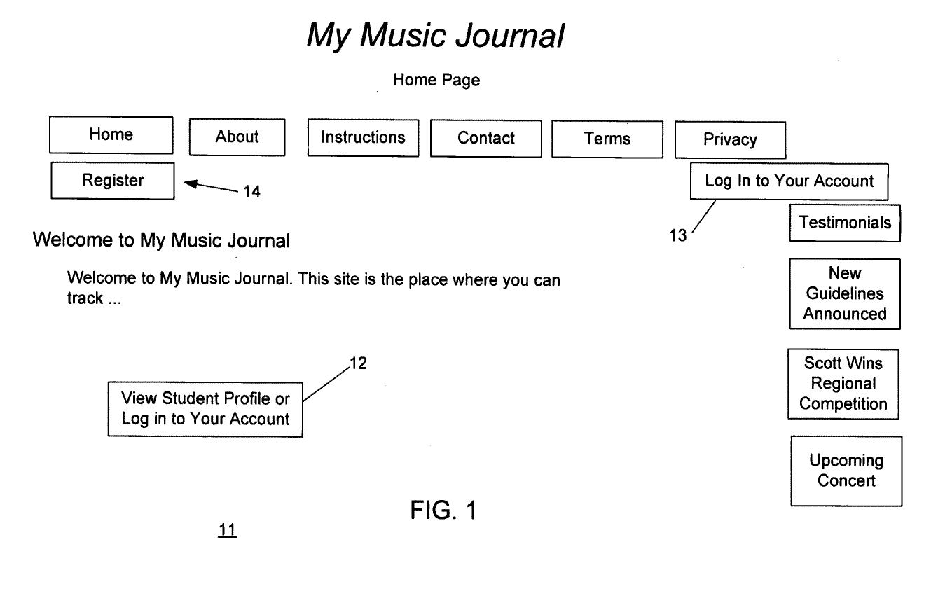

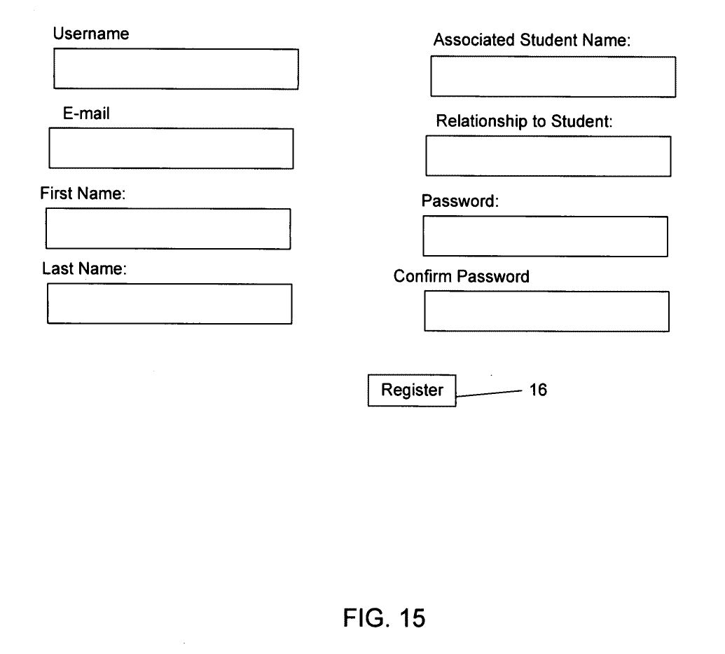

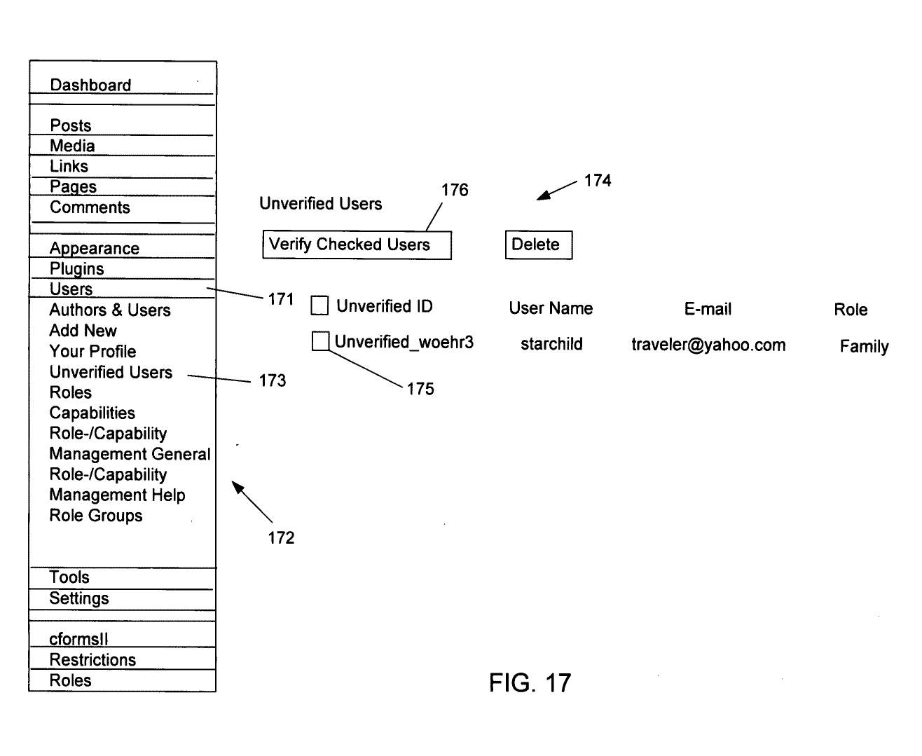

In FIG. 1 a new student has logged onto website 6. Before he can fully utilize the website, the student needs to register. In the course of that registration, the student (or his parent or guardian) is required to agree to a set of terms and conditions prepared by the arts studio. These terms and conditions clearly explain the requirements of the student and his teacher/mentor for compliance with the United States Copyright Act. The student clicks on register button 14. This takes the student to the registration page (FIG. 15). Here the student fills in the appropriate identifying information in the designated boxes. After he has filled in his identifying information the student clicks on register button 16. An email is then sent to the administrator at administrator computer 3 notifying the administrator of the registration. Also, the student view on his monitor the webpage shown in FIG. 17 informing him that his account is being reviewed by an administrator and that he will be notified when it is active.

In another preferred embodiment, the student is pre-registered by the administrator prior to logging onto the website. In this preferred embodiment it is not necessary for the student to register as described above. However, provisions should be made for the student or a responsible person to confirm that the terms and conditions of the studio will be complied with.

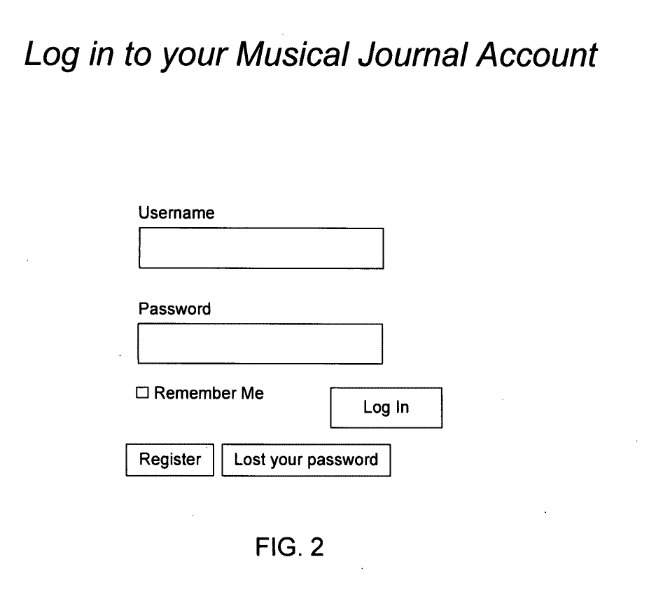

After approval by the administrator the student is able to log on to website 6 (FIG. 18). In FIG. 1, the student has entered into student computer 5 the website address for website 6. The student then clicks on either button 12 or button 13 to log on to his account, after which the student views the image on his monitor shown in FIG. 2.

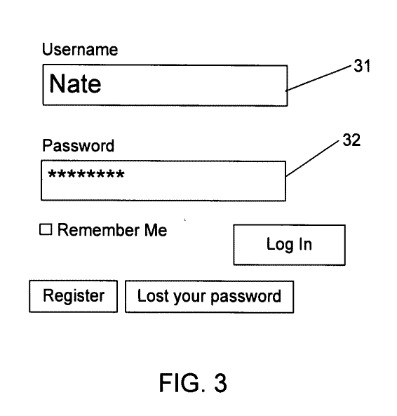

In FIG. 3, the student has entered his username and password into boxes 31 and 32 as shown. He then clicks on button 33 to complete the log on process.

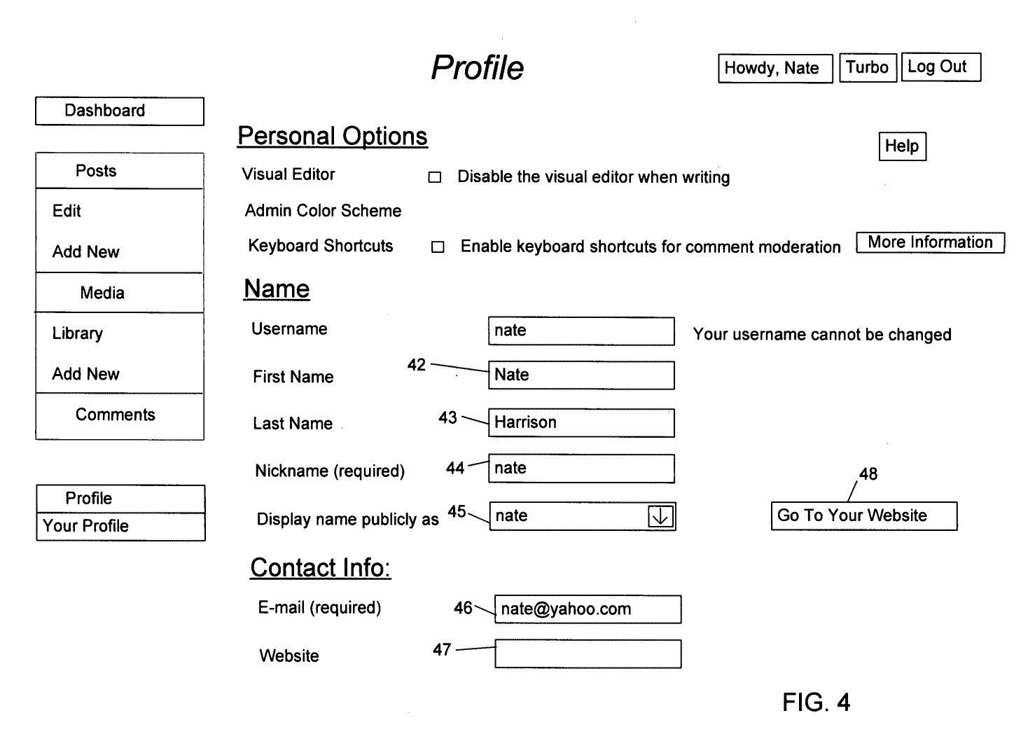

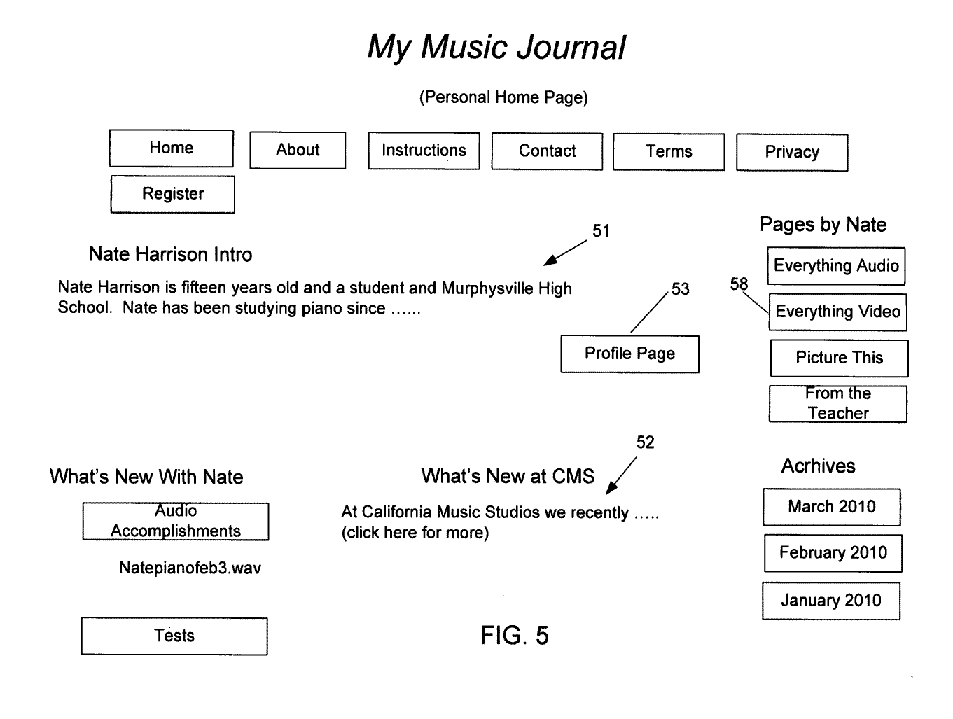

In FIG. 4, the student has been directed onto his profile page. From this page the student can edit and add profile information by inserting text into boxes 42-47. In one preferred embodiment, once the username has been assigned, it cannot be edited at the profile page. From the profile page the student clicks on button 48 to proceed to his personal homepage (FIG. 5). The student can also edit or add posts to his home page. For example, the student can click on Add New button 49 to add a new post to his website.

In FIG. 5, the student is at his personal home page. His personal introduction 51 is on this page as well as update information 52 dealing covering recent events at the arts school. To modify the home page, the student clicks on profile page button 53 to go back to the profile page.

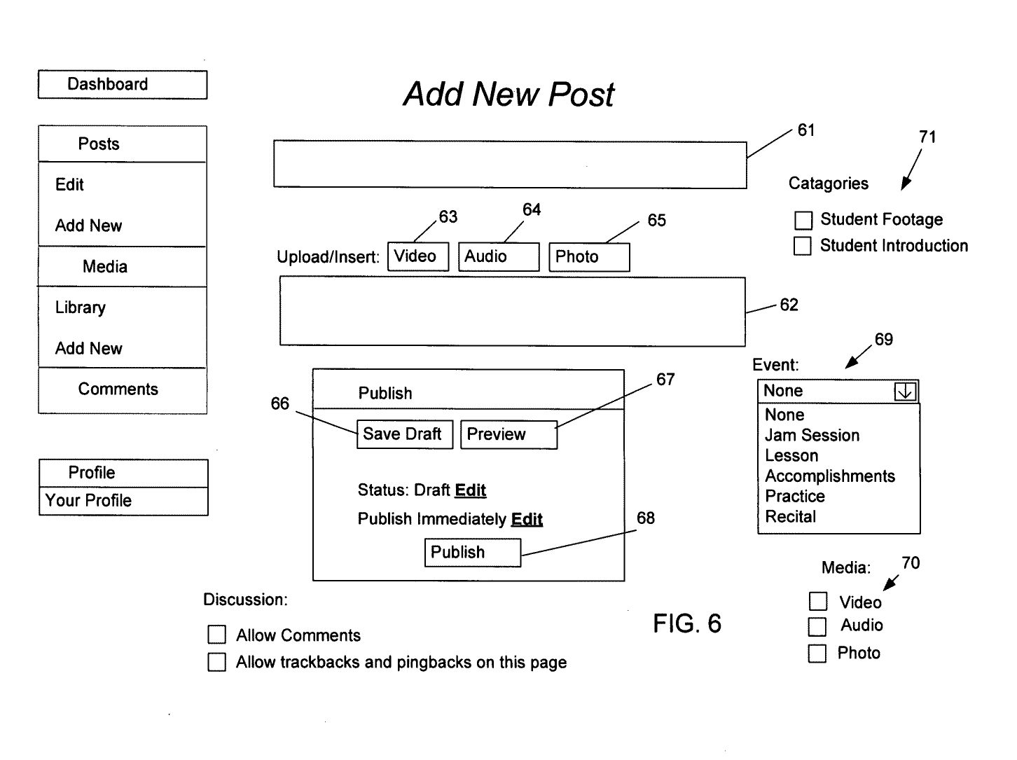

In FIG. 6, the student is on the correct web page for adding a new post. The student fills in the title of the post by filling in box 61. The student can then fill in explanatory information regarding the post by filling in box 62. Finally, the student clicks on button 63, button 64 or button 65 to start the upload process for uploading the post to website 6. The student can then either save the post for later upload by clicking on button 66 or preview the post by clicking on button 67. The student must classify the nature of his post by selecting one of the categories from drop down menu 69 and the media type by making a selection from media selection area 70. For example, a student might want to upload a video of him playing piano and classify it as an Accomplishment Video. Once the student is satisfied with the quality of his post he can publish it onto website 6 by clicking on button 68. These classifications determine placement of the post on the student pages.

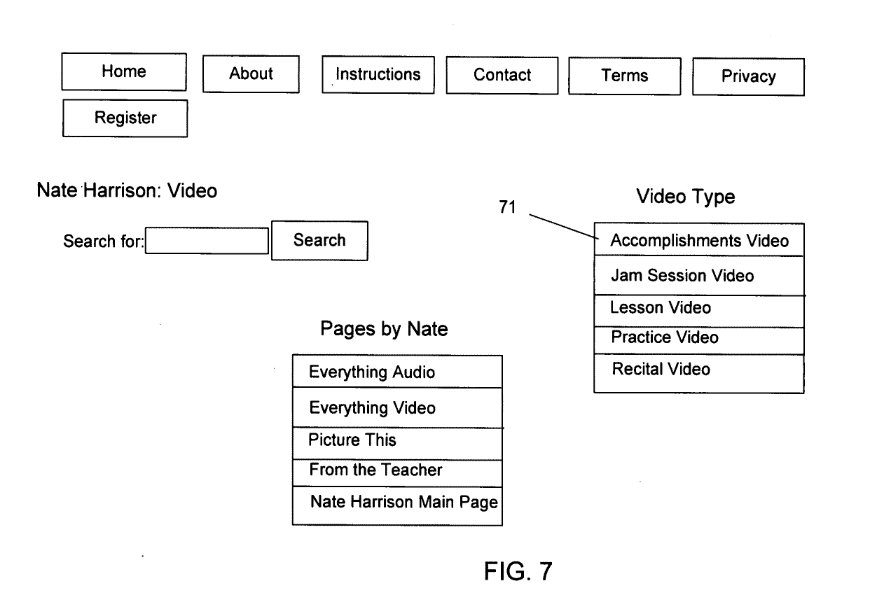

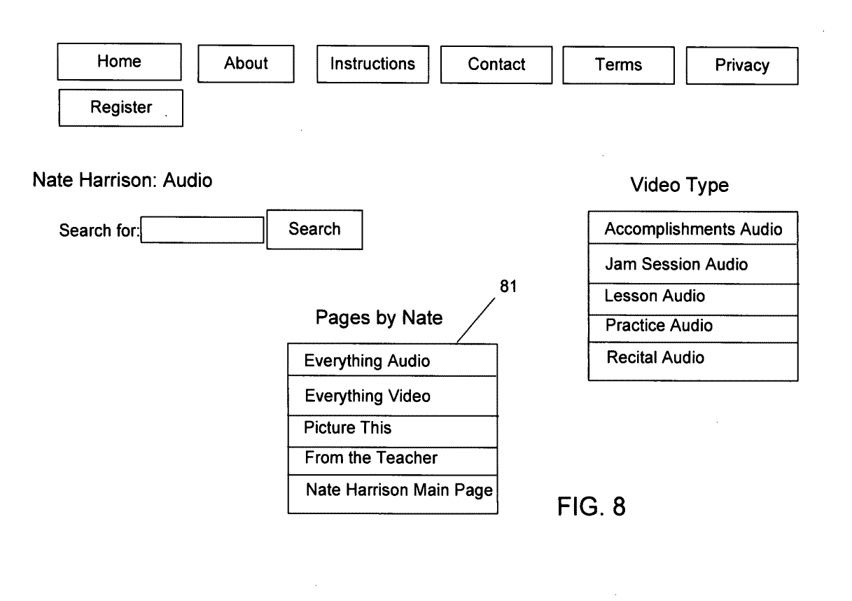

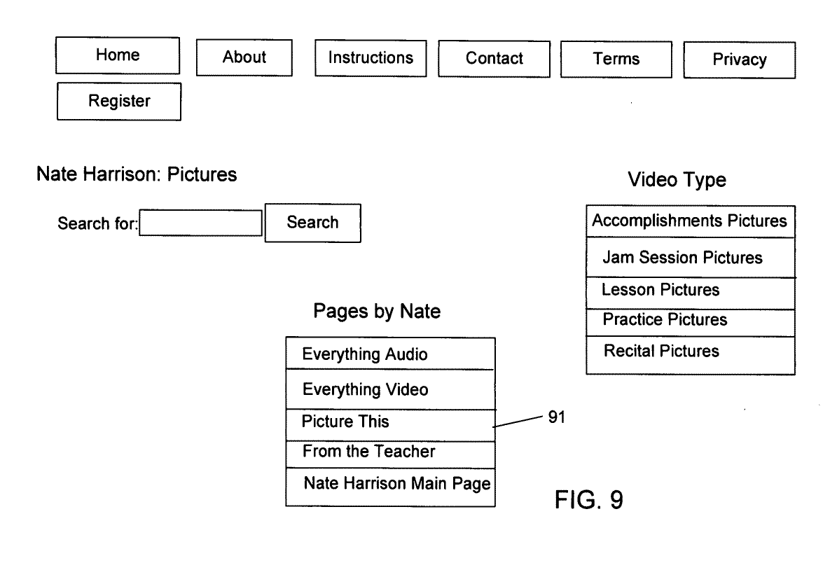

In FIG. 7, the student has clicked on Everything Video button 58 from his homepage (FIG. 5). From here, the student can click on specific video types. Similarly, in FIG. 8, the student has clicked on Everything Audio button 81. From here, the student will then be able to access specific audio recordings. In FIG. 9, the student has clicked on “Picture This” button 91. From here, the student will then be able to access specific photographs related to his arts. In a preferred embodiment one-month worth of posts are displayed. At the conclusion of the month, the posts are automatically transferred to the “Archives”.

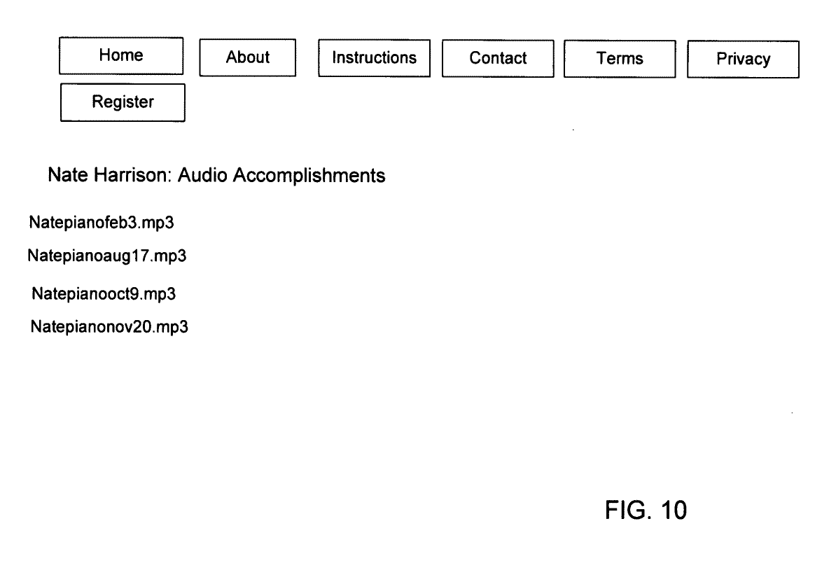

In FIG. 10, the student has clicked on Accomplishments Video button 71 (FIG. 7). The Audio Accomplishments webpage shows a listing of uploaded audio recordings of the student playing piano. To listen to a particular recording, the student clicks on the recording of interest.

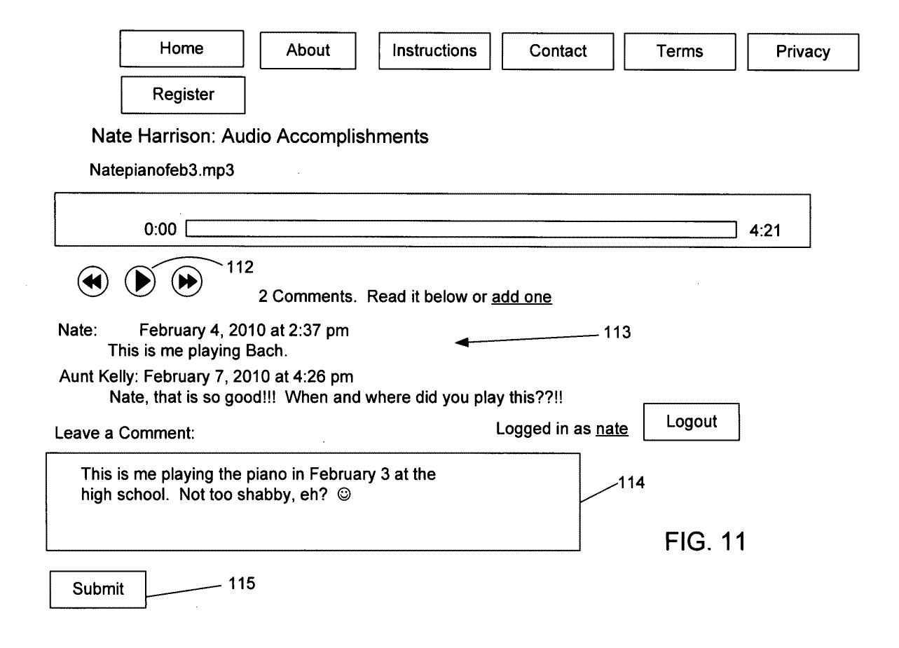

In FIG. 11, the student has clicked on “natepianofeb3.mp3” (FIG. 10). The student can now listen to the upload by clicking on arrow 112. The student can read comments posted by himself and others by reading them at comment area 113. The student can make additional comments by entering the comment into box 114 and clicking submit button 115.

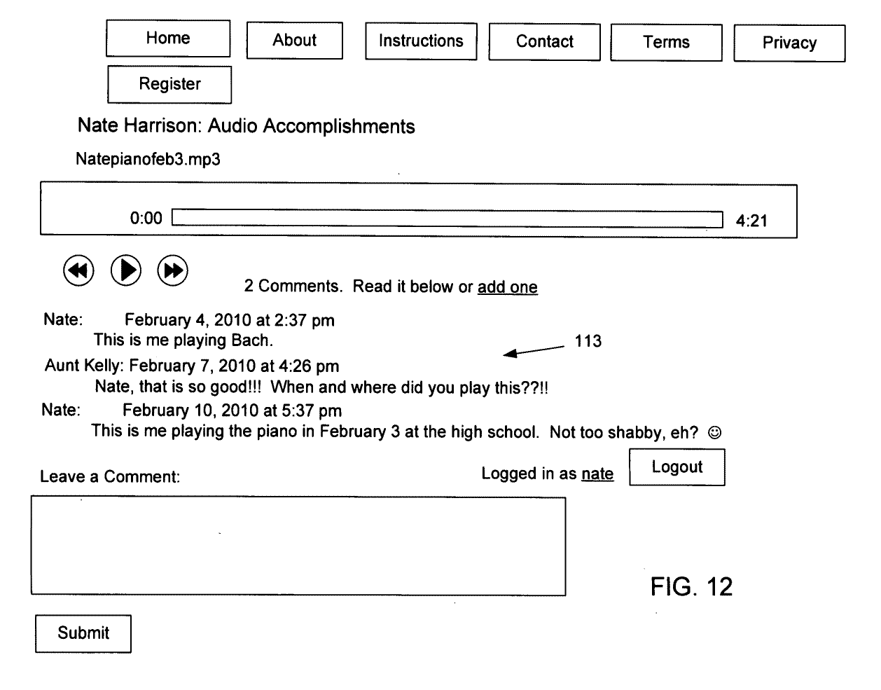

In FIG. 12, the student has added an additional comment that can be read at comment area 113.

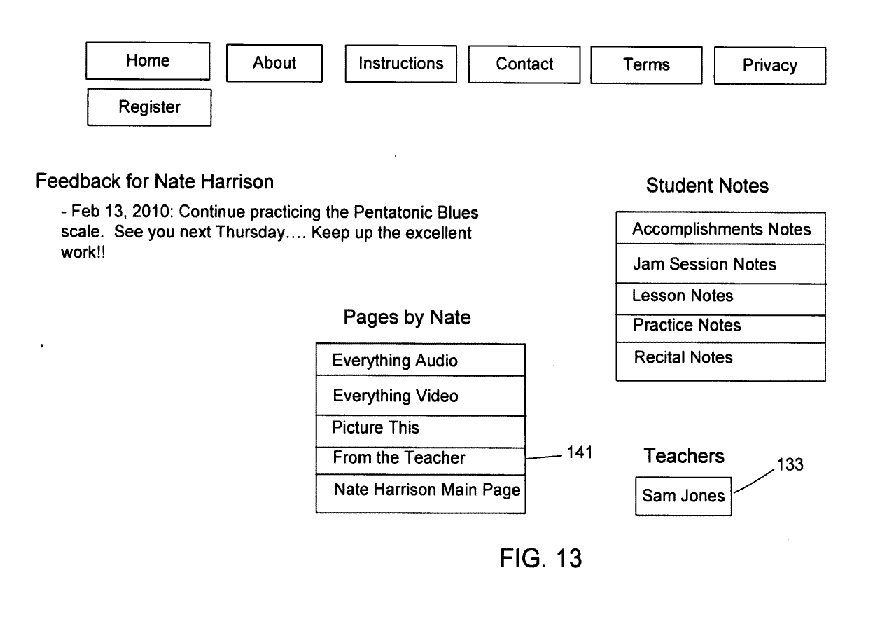

In FIG. 13, the student has clicked on From the Teacher/mentor button 141 to read feedback from his arts teacher/mentor. The arts teacher/mentor's name is Sam Jones. To view the arts teacher/mentor's web page the student can click on button 133. In FIG. 13, the teacher/mentor has observed the student playing the piano and has made comments giving the student instructions to practice the pentatonic blues scale and also words of encouragement to “keep up the excellent work!” In a preferred embodiment the student may have several teacher/mentors all of which would be listed on the students From the Teacher/mentor page. Preferably, only posts for the “logged in” student will be shown on the From the Teacher/mentor page. For example, if Sam Jones has ten students, only the posts for the “logged in” student will be available.

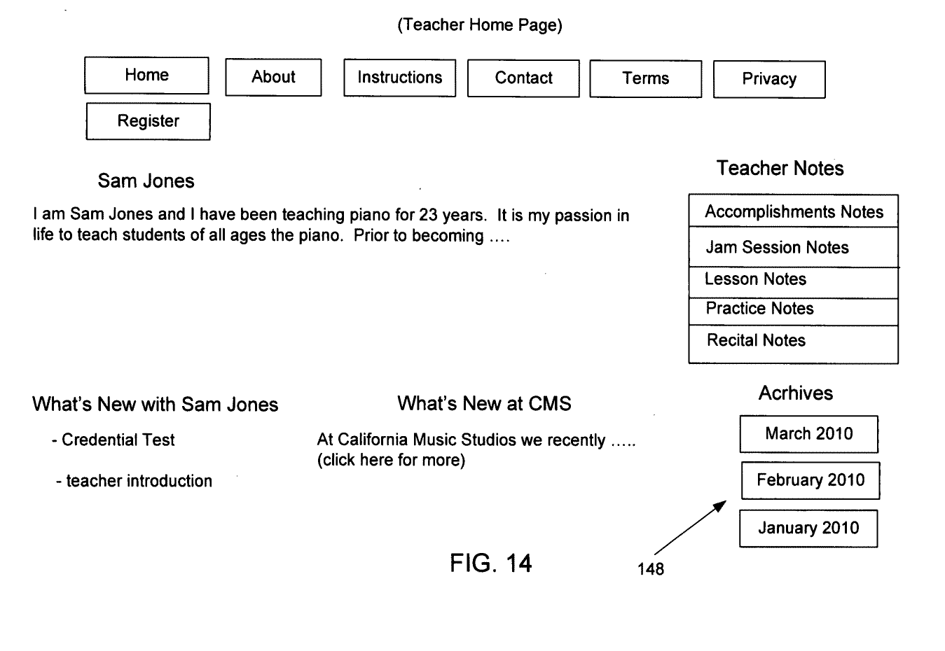

In FIG. 14, the student has navigated to the arts teacher/mentor's home page. Here the student can read information about his arts teacher/mentor and review the teacher/mentor's notes and archived information by clicking on archive buttons 148.

### Registration of the Friend and Family Member

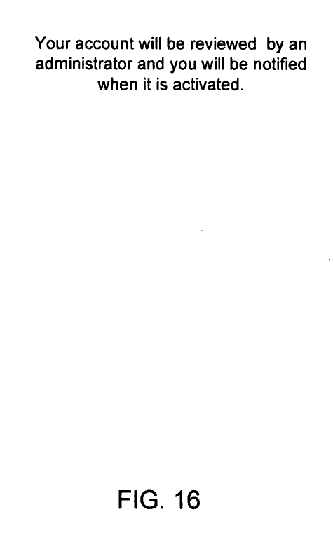

A friend or family member can register at website 6 (FIG. 18). In FIG. 15, a family member has arrived at a registration page after clicking on register button 14 (FIG. 1). The family member fills in the appropriate information and clicks on register button 16. The family member then views on his monitor the webpage shown in FIG. 16 informing him that his account is being reviewed by an administrator and that he will be notified when it is active. An email is then sent to the administrator at administrator computer 3 notifying the administrator of the registration attempt. Additionally, an email is sent to student computer 5 notifying the student of the registration attempt. Once the student verifies that he is willing to allow the family member access to his account information, the administrator sends notification to the family member that his registration has been accepted.

### Administrator Approval of Log on Attempt

In FIG. 17, the administrator has clicked on Users button 171 to bring up drop down menu 172. The administrator then has clicked on unverified users 173 to bring up display 174. After receiving the request from username “starchild” and after receiving approval from the arts student the administrator verifies the user by first clicking in box and then clicking Verify Checked Users button 176.

### Local Area Network

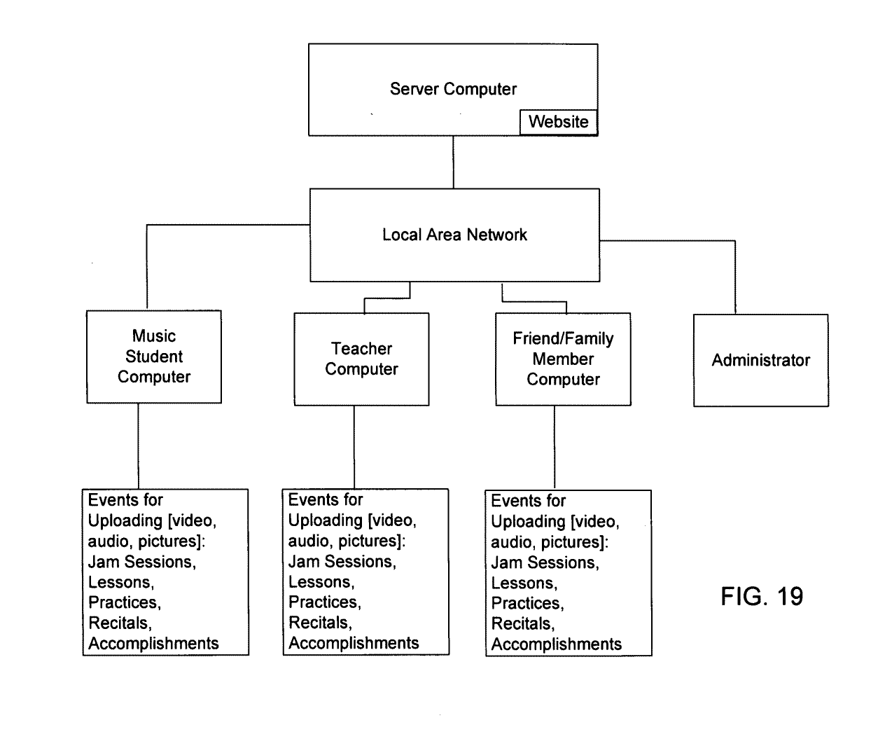

Although the above preferred embodiment discussed the utilization of the Internet for providing the connectivity between the arts student, the teacher/mentor, the friend, the family member and the administrator, it is also possible to set up a Local Area Network to establish connectivity. For example, a Local Area Network can be set up at a university or other arts school. Server computer 1 would be at the university and the Local Area Network would provide the connection (FIG. 19).

### Student Motivator

Website 6 functions to motivate the arts student to learn and practice arts. It is fun and rewarding for the arts student to share performances to be observed by friends and family members. Additionally, a record is preserved at website 6 of the student's progress. The student, his teacher/mentor and friends and family members will see from month to month and from year to year how the student has improved. This will serve to encourage the student to practice even more.

### Teaching Tool

Website 6 is an incredible teaching tool for use by an arts teacher/mentor. The arts teacher/mentor can communicate and monitor all his students who are registered through website 6. The teacher/mentor can observe their latest practice session and make constructive comments. The teacher/mentor can additionally record his own arts lesson or performance and upload it for the benefit of the student. The student will be able to watch and listen to the arts performance and lesson and make adjustments accordingly.

Family and Friend Connection Family members and friends are able to communicate with the arts student and comment on his progress. In this fashion, website 6 functions to strengthen family ties and friendships.

### Third Party Computer

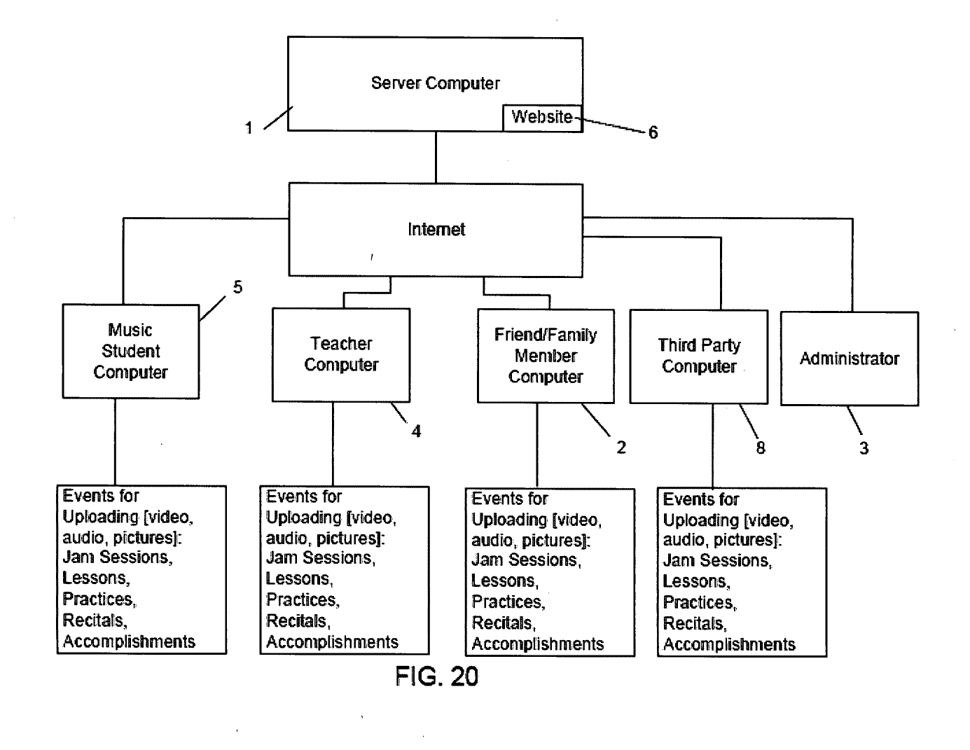

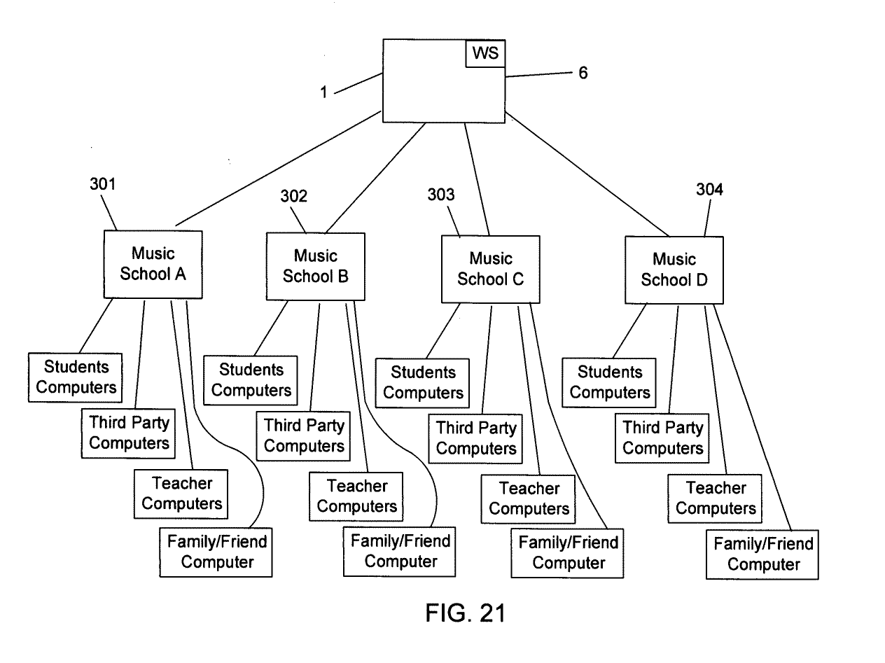

The above preferred embodiments disclosed the utilization of family/friend computer 2. Family/friend computer 2 is just one example of a third party computer. Third party computer 8 (FIG. 20) is a computer that allows someone other than the student and his teacher/mentor to follow the progress of the student as he learns his instrument. Besides a family member or a friend, another example of someone who would operate a third party computer is any individual or social network member approved by the student and also by the administrator. There are many types of social network members who may be interested in operating third party computer 8. For example, another student interested in learning a arts instrument similar to that of the students might seek approval and be permitted to operate the third party computer. He will then be able to track the earlier student and then decide if this is something he might also like to learn and study. Or, an individual interested in learning more about a particular teacher/mentor might seek approval and be permitted to operate a third party computer. The individual could then observe the teacher/mentor in action and decide if this would be a good instructor to hire.

### A Source of Advertisement

Website 6 is a tremendous source of advertisement to the operators of website 6 as well as the individual teacher/mentors who interface with the students by utilization of website 6. Friends and family members who observe the student may become interested in arts. Soon, they too may want to study arts. Accordingly, they may communicate their desires to the operators of website 6 and/or a specific teacher/mentor who is associated with the website. However, if Website 6 is to be made available to the general public, special care should be taken to avoid copyright infringement. This will require close scrutiny by the administrator and may call for periodic reviews of the web site by a copyright expert.

### Administering Website Six

In a preferred embodiment, as explained above website 6 is controlled by an administrator via administrator computer 3 (FIG. 18). In a preferred embodiment, administrator 6 is employed by a arts school and is specially trained in copyright law. In this preferred embodiment, access to website 6 is generally by the administrator free of charge. However, the administrator may also charge a fee for premium access. Premium access may allow users to have enhanced upload capability to upload and store larger sized files than would be allowed to typical users who are accessing website 6 free of charge. Also in another preferred embodiment, the administrator may license website 6 to other administrators from different arts schools. The other administrators from the other arts schools can create their own websites with their own students, teacher/mentors, and third party members.

Website Functions With or Without the Participation of a Arts Teacher/mentor In the above preferred embodiments, it was described how the arts teacher/mentor interacts with the student through website 6. It should be understood that a arts student can access the website and receive benefits from the website without the participation of the arts teacher/mentor. In this preferred embodiment, the student accesses website 6 via student computer 5. The student interacts with friends and family members through website 6 in a manner similar to that described above. The friends and family members access the website 6 via family/friend computer 2. This immersive interaction between the student and his friends and family members positively impacts the student and he is encouraged to study arts longer so as to become proficient in his arts form.

### Other Preferred Embodiments

### Utilization by Multiple Arts Schools

Option A: Multiple Schools Administered by a Centralized Website In another preferred embodiment, multiple arts schools can utilize the website 6 (FIG. 20). In one preferred embodiment, the main administrator of centralized website 6 refers to website 6 as “My Arts Journal”. A software package is then sold to multiple arts schools. For example, in the system shown in FIG. 20, each arts school A-D interfaces with its own student population. To utilize website 6 a school will go to website 6 and click on a “Get the Journal Button”. For example, if School A joined website 6 a preferred “School A” homepage would read as:
http://www.MyArtsJournal.com/School_A

The initial set up of the system will be handled by the administrator of centralized website 6 via administrator computer 3. There will be options for ongoing administration of the purchasing school and upgrades.

### Option B

### Satellite Site Administration

For satellite site administration, the initial set up of the systems depicted in FIG. 18 will include a complete arts journal site. This process will be automated. The interested party will purchase the license to run the site. The purchase price will include the initial site install and any bug fixes for a specified time period. Feature enhancements to the system depicted in FIG. 18 will be made available to the satellite sites on a fee basis. Upon completing purchase details, the purchaser will be instructed to enter site centric details. Upon submitting these details the site will be automatically created and immediately available. The purchaser will receive instructions to administer and brand the site with their logo. The site will function as explained above in reference to FIGS. 1-18.

### Administrative Options

The satellite sites will need to populate the site with users. At the time of purchase the purchaser will have the option to choose their administration options.

Option A: Centralized Administration
Centralized Website Administrator enters student population

Option B: Satellite Site Administration
Students register themselves
Purchaser administrator populates site

### Expanded Upload Functionality

The purchasing school may opt to install the module to have upload limitation based on file size on a per fee basis as described below in the Payment by Users for Additional Uploads section of this blueprint document. In this instance, the purchasing school must obtain an Internet Merchant Account to facilitate payments. The installment and activation of this module would be handled by the centralized administrators.

### Considerations for Establishing a Merchant Account

An Internet Merchant Account is procured to take real-time processing of credit card payments and develop a shopping cart system to handle payments, and then modularize this section for resale.
Version control of the website software is established. Because the overall plan is to continually offer enhancements and additionally, as bugs are worked out of the system, various versions of the software will be a part of that process. Tight version control is preferably put in place. The initial purchase preferably includes all bug fix version releases—however feature enhancements may be charged separately as add-ons.
As stated above—server considerations for satellites is preferably addressed. Defining a relationship with a hosting company, or with Support and Development (SD) Support could provide additional income stream while providing a benefit to the purchaser.
All user manuals, administration manuals and licensing agreements will preferably be developed. The manuals can be taken from the centralized website user manuals and modified, the licensing agreements, what people are allowed and not allowed to do with the software, will need to be made from ‘scratch’.
Marketing considerations are preferably taken into consideration. For example, the level of Internet marketing is preferably considered.
Support considerations: In a preferred embodiment, blogs, wikis, and forums are added to support the software. Support included with the purchase is negotiable. Also, preferably, efforts are taken so that customer expectations are high based on service offering to ensure a positive experience.

### Payment by Users for Additional Uploads

Preferably there is a file size upload limitation (per month) for users of website 6. Also, preferably, users of website can opt to pay additional fees for uploading beyond that limitation. Students, Family/Friend and Teacher/mentors would have the ability to pay for additional uploads for any student user group. So if for example, Grandma came to the site to upload her video of a recital, but upload limit for the account had been met—she could purchase additional space to upload her video if desired.

### Preferred Upload Limitation Process

In a preferred embodiment, the system is set up so that each time a user from any student group uploads video/audio or photos, a folder is created at the server for the student group, based on Student ID. Inside that folder, each month a new folder is created to store that month's set of downloads. When the user group meets the monthly limit a message would display indicating upload limitations are met for the month with a link to purchase more space. Preferred options regarding how this space would be allocated is addressed below. In one preferred embodiment, the system only displays the user limit reached message with email address to contact the administrator at centralized website 6.

### Further Upload Limitation Considerations

In one preferred embodiment it is possible to charge for blocks of space to ‘pay as you go’. In this preferred embodiment, the user could purchase just enough space to upload the desired file. This option is attractive because it is user friendly. However it may be more difficult to set up because the administrator will have to programmatically say, this user group has purchased this amount of additional space. Allow it for this instance. But disallow the next time and show the upload limit message.

In another preferred embodiment membership levels with a monthly fee can be purchased for a desired amount of additional space. In this preferred embodiment membership plans could be set up that allow for X amount of additional space. This is easier to create because plans can be set up to place different student ID groups into different categories of membership one time per month, instead of on a continual per instance basis.

### Third Preferred Embodiment

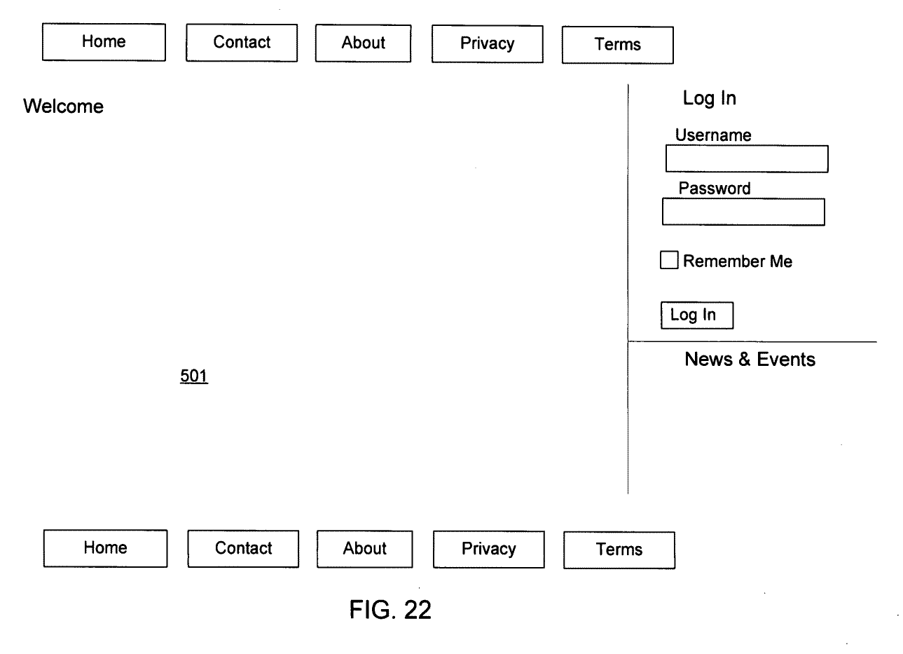

This Third preferred embodiment is similar to the second preferred embodiment. It is described by reference to specific web pages (FIGS. 22-30) established by Applicants to permit these secure private Internet systems for monitoring progress of arts students.

FIG. 22 shows home page 501 for the Arts Journal site. This and the pages in the main navigation bars in the header and footer are the only pages available to the public. The Sidebar area offers a log in panel and a News & Events section that features three News & Events items (only one shown). Upon Login the user is directed to various pages depending on the user's role. There are five defined roles within the system. Student, Teacher/mentor, Family/Friends, an Administrator and a Super Administrator.

### Student Login Landing Page

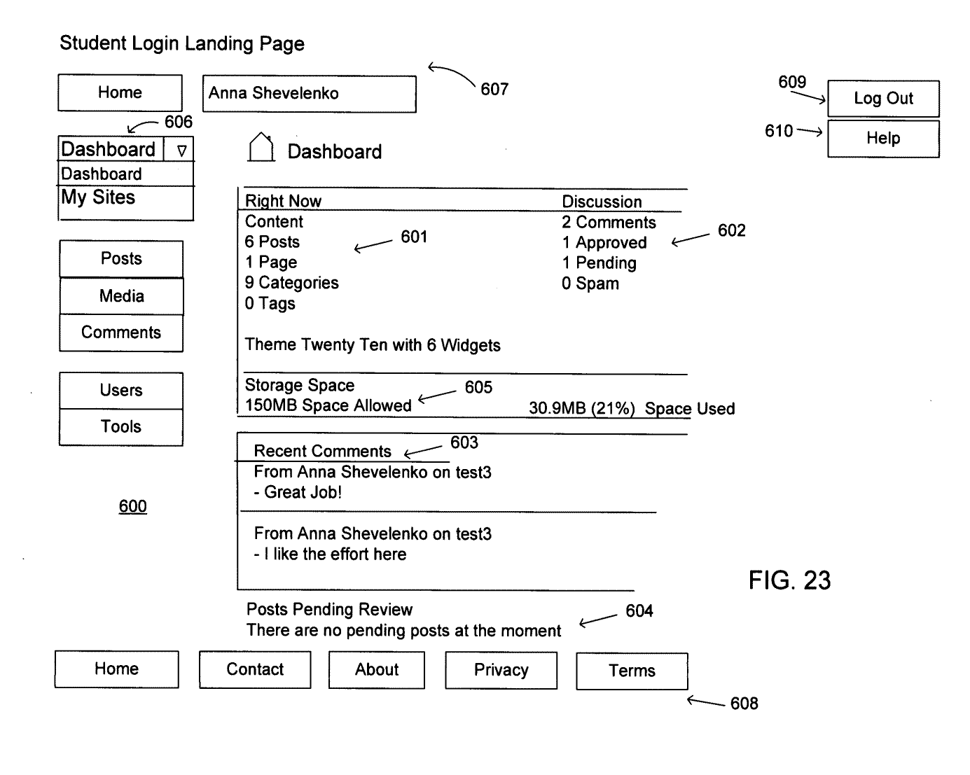

FIG. 23 is a screen shot of the student landing page after login with explanation for each role type. Upon login the Student is directed to their Journal's Administration Panel as shown in FIG. 23. The panel displays data pertinent to the Student's journal including:

Item 601: Total number of posts, pages, categories and tags on the Student's journal

Item 602: Total number of comments and status

Item 603: Recent Comments made on the Student's journal

Item 604: Any posts a Teacher/mentor or Family/Friend role has made in need of review

Item 605: Storage space allotted and utilized for the month 2

Item 606: Navigation to all back-end administration processes

Item 607: Navigation to front-end journal pages

Item 608: Main MMJ navigation items

Item 609: Log out from the MMJ system

Item 610: Contextual help—Clicking this gives instructions on the screen shown and changes based on the screen the Student is accessing.

The Student has ultimate control over content on their MMJ. They may make all the posts and/or comments they would like and determine whether to display them or archive them for future or immediate use. All comments and posts made by Family/Friends or Teacher/mentors must be approved by the Student before they will appear on the MMJ. All posts made by Family/Friends or Teacher/mentors must be reviewed by the Student. If the Student chooses they may place the item on their MMJ or they may choose to simply archive it in the system and not display it to the members of the MMJ. The Student may also add new Family/Friend members (up to 25). The processes to execute these functions are described in further sections of this document.

### Family/Friend and Teacher/Mentor Login Landing Page

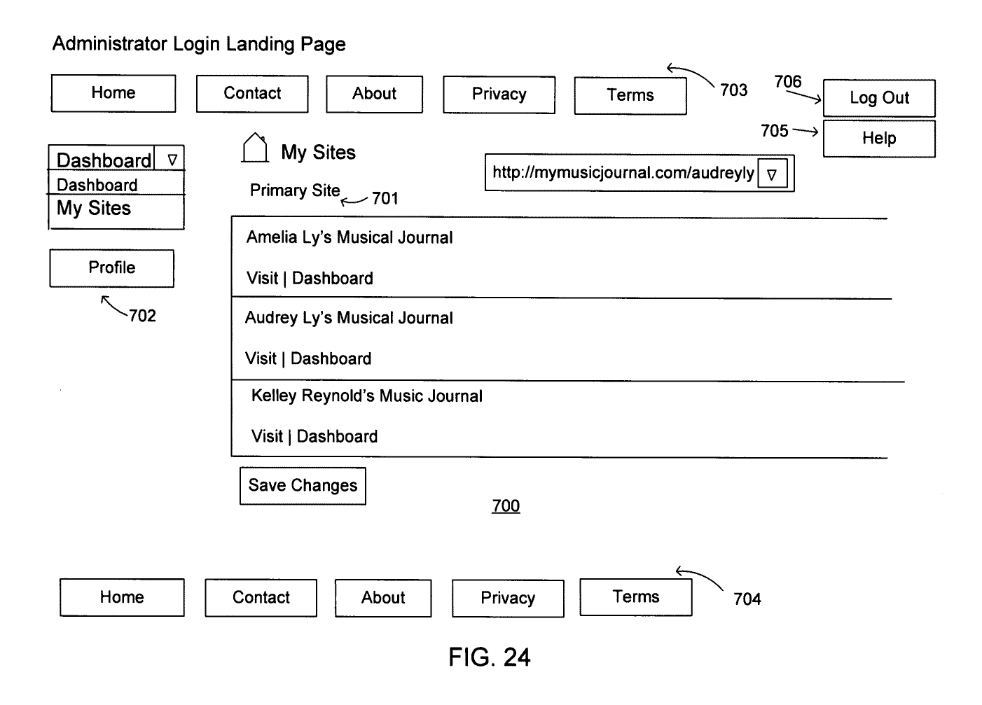

Upon login the Teacher/mentor or Family/Friend member is directed to a page 700, FIG. 24, that displays the MMJs the Teacher/mentor or Family/Friend is a member of. Note the following:

Item 701: List of each Student the Teacher/mentor or Family/Friend is associated with. Clicking on the link will take the them to the Student's front-end MMJ where they have the ability to choose to comment or post (process described later)

Item 702: Link to profile

Item 703: Main MMJ navigation

Item 704: Main MMJ navigation

Item 705: Contextual help—Clicking this gives instructions on the screen shown and changes based on the screen the Teacher/mentor is accessing.

Item 706: Log out from the MMJ system

### Administrator Login Landing Page

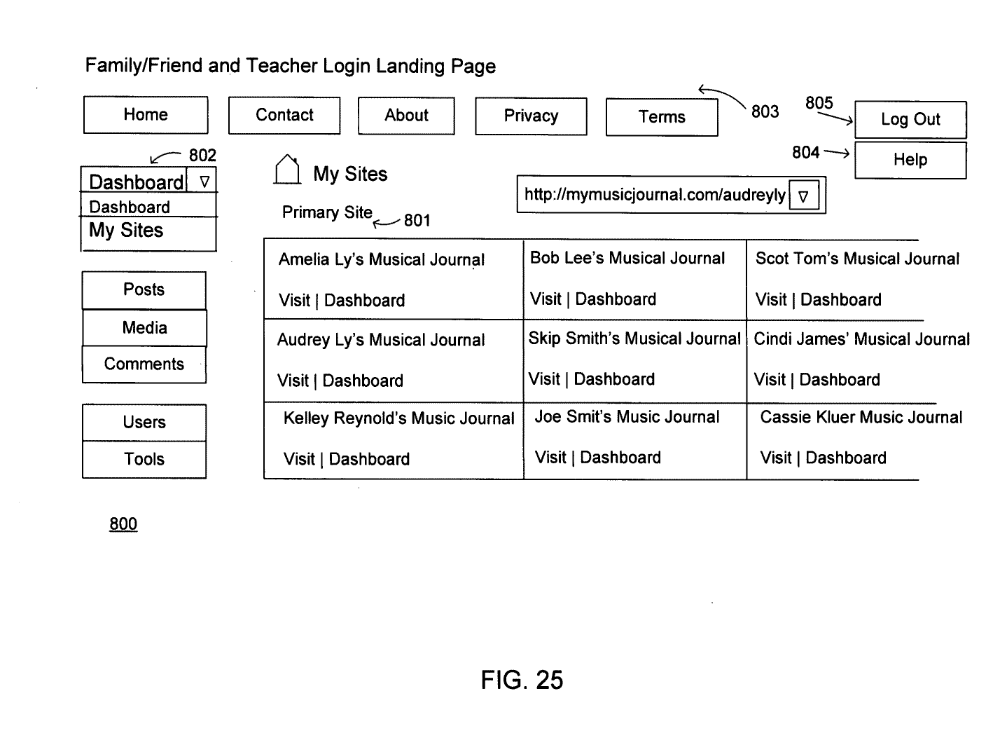

Upon login the administrator is directed to page 800 (FIG. 25) that displays all the MMJs in the system. Clicking on any of the names will allow the admin to access the front—end of the MMJ chosen where the admin can then choose to access the administration panel for that MMJ, add or edit posts or comments. These processes are described in further sections of this document. The admin may also create, edit or delete and MMJ and add posts or pages to the main MMJ. Note the following:

Item 801: Lists all MMJs in the system

Item 802: Link to backend processes for the main MMJ site

Item 803: Main MMJ navigation

Item 804: Contextual help—Clicking this gives instructions on the screen shown and changes based on the screen the admin is accessing.

Item 805: Log out from the MMJ system

### Super Admin Login Landing Page

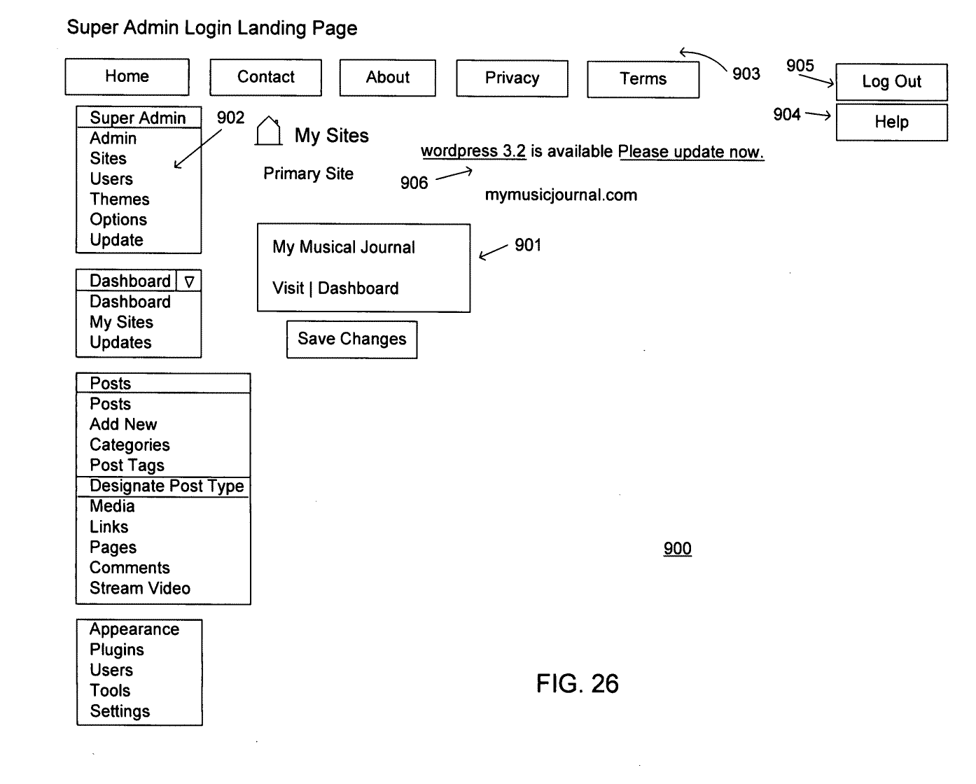

A Super Admin has full control of the system via super admin login landing page 900, FIG. 26. This role can add/edit/delete and MMJ on the system and change the structure of the system through appearance, plugins, tools, etc. The super admin may also add pages and posts to the main MMJ page. Note the following:

Item 901: Shows the MMJ main site

Item 902: Link to backend processes for the main MMJ site

Item 903: Main MMJ navigation

Item 904: Contextual help—Clicking this gives instructions on the screen shown and changes based on the screen the admin is accessing.

Item 905: Log out from the MMJ system

Item 906: Informs the Super Admin of the latest version of Wordpress availability.

### Student Processes

This section of the document describes the Student processes on the MMJ. Below is a list of each Student process:

Post Activities
Add/Edit/Delete Posts for use on MMJ main page or Teacher/mentor pages or to Archive
Review and approve/decline posts

Comment Activities
Review and approve/decline comments

Other Activities
Add users
Edit Profile

### Post Activities

### View all Posts on the MMJ

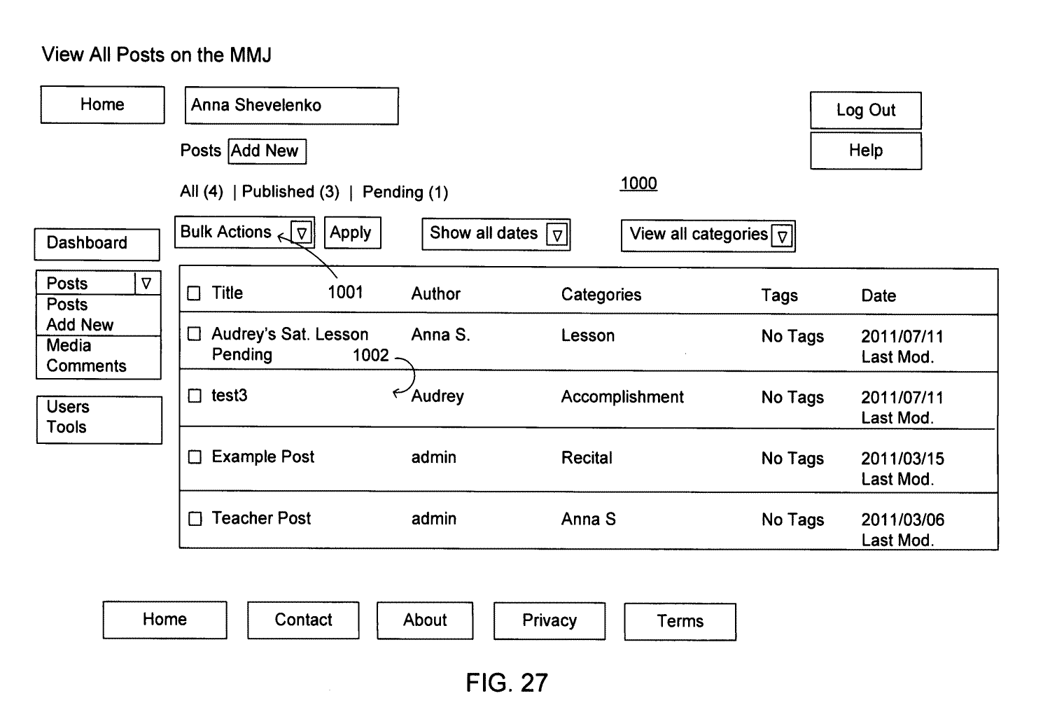

The Student may access screen 1000, FIG. 27 by clicking posts in the left navigation bar, clicking posts from the ‘Right Now’ section of the login landing page or by clicking edit posts from the front end main MMJ or individual post pages. Note the following:

Item 1001: List of all posts—these shows all published posts and indicated whether the post is pending. If the—Student clicks on the post, the Student arrives at the edit post screen. If the post is pending they may approve it for display or archive in their MMJ or they may decline or delete it. Upon hover of the post title, the Student may quick edit various elements of the post, edit the full post in the edit post screen, delete, or preview the post in the front end of the system.

Item 1002: Note the pending status of the first post in the list. Anytime a Teacher/mentor or Family/Friend member makes a post, they submit it for Student review. The Student can view pending posts from this screen or by clicking the pending posts section from the Student login landing page. If the Student clicks on the pending post, the full post edit screen becomes available. The Student can then review the post and determine whether to delete, approve and possibly make the post available on the public side of their MMJ. The top, bottom and left side navigation items remain the same as well as the log out and the contextual help.

### Post Activities

### Edit/Add/Approve Posts

### Make Available on Teacher/Mentor or Main Journal Page

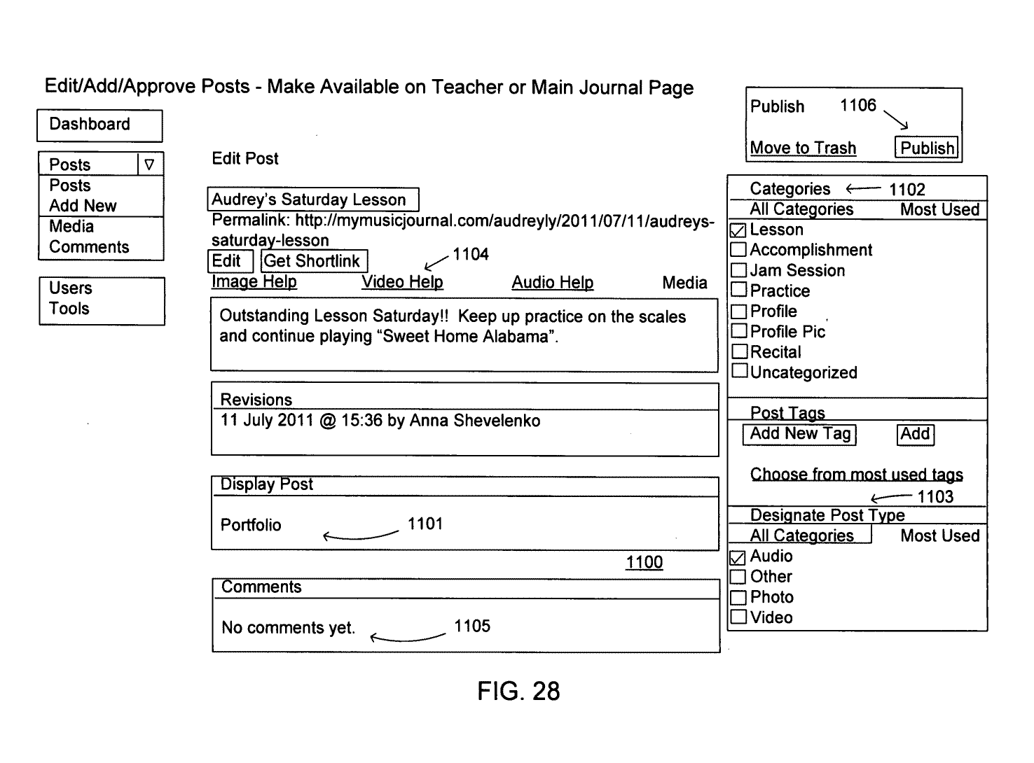

The Screen shown in FIG. 28 allows the Student to view or create the post content and determine placement or archive status on their MMJ. This is the same screen that is used when the Student makes a new post. This screen is accessed by clicking a post in the previous screen or when the Student clicks Add New Post from the left navigation bar in the Student Admin bar or from the front end My Journal sidebar. The screen depicted below displays a pending post, however the processes remain the same regardless of whether the post is originated by the Student or a pending post from a Family/Friend or Teacher/mentor role post type. Note the following:

Item 1101: Display Post: If the Student clicks the box MyJournal, the post will be public on the main MMJ page. Users then may click on the post to view complete content and comment. If the Student does not click the MyJournal box, the post is archived by category and post type. At any time the Student may choose to bring the post out of archive status and display it on their main MMJ page by checking the MyJournal box. In future iterations of the MMJ, the Student may also choose to place the post in a publicly pay per view available area here as well. This will allow any user of the MMJ view the post for a fee without being a member of the Student's MMJ.

Item 1102: Category Listing—if the Student selects the Teacher/mentor's name from the category box—the post will be available on the Teacher/mentor's page. This page is only available to the Student and the Teacher/mentor. The Student can select any number of categories they would like to categorize the post. When the Family/Friend member or Teacher/mentor makes a post, they may suggest a designation for category, but the Student may choose to change this designation. Selection of categories at this point does not affect where the post appears. Additionally, the Student may choose Profile to place a profile about themselves in the sidebar and Profile Pic to include a picture.

Item 1103: Designate Post Type: here the Student designates the post as an audio, video, photo or other. Again, the post maker may make suggestions but the Student has final control over post type. Again designation of post type does not affect placement of the post.

Item 1104: In the instance the Student is making a new post or editing a current post, the Student may upload audio, video or photos to include in the post. Any items added go against the allocated space for the month and will appear in the “right now” section on the Student login landing page. Next to these buttons are contextual help that allow the Student to gain more information about how and what file type to upload to their journal. MMJ does provide video clips from Student recitals for Student to place on their MMJ. In this case, when the Student chooses to add video, they may search for any videos uploaded to their MMJ video clips file to add to any post of their choice.

Item 1105: This box shows all the comments approved or pending related with the post being viewed. The Student may click on the post to delete, edit or approve a pending post.

Item 1106: Once the Student has added all content, or edited the content from a pending post, they will click the blue button at the top right which is either—publish in the case of a pending or new post, or update if the Student is editing the post. The top, bottom and left side navigation items remain the same as well as the log out and contextual help.

### Comment Activities

### Review and Approve/Decline Comments

Comments are enabled by default. This means anytime a post is added to the MMJ members of that MMJ may make posts or comments. The Student may turn off the ability to comment in the edit posts screen by clicking quick edit and deselecting the allow comments box. The Student may manage comments in several ways:
Clicking Comments in the left side navigation bar
Utilizing the Comments box on the Student login landing page
Editing the post in which a comment is awaiting moderation

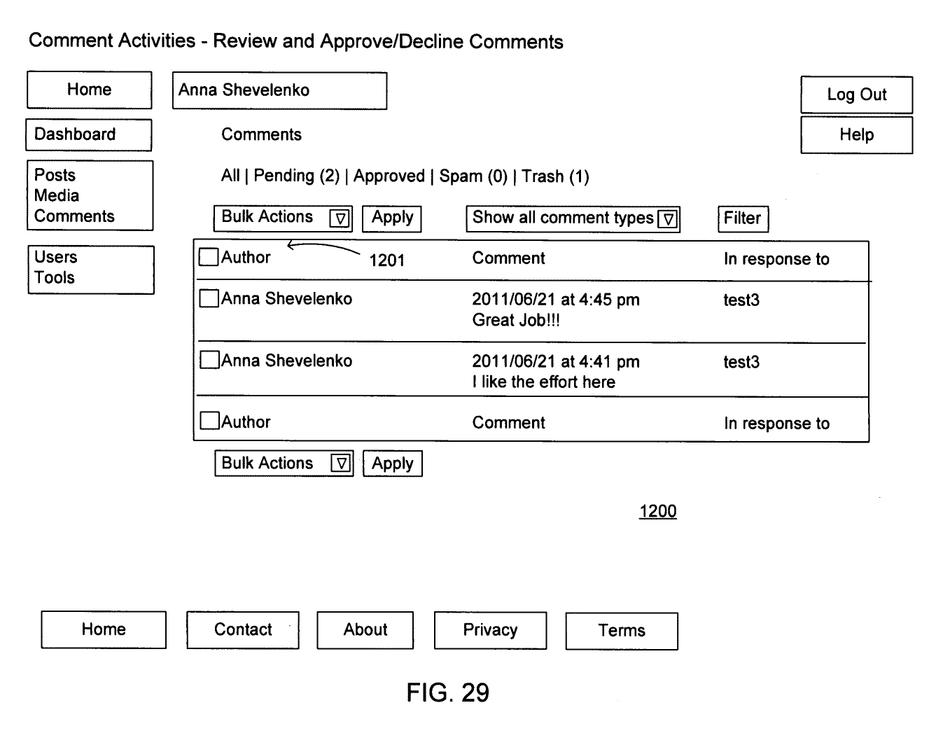

The process to moderate comments is the same regardless of the method used. FIG. 29 shows screen 1200. Note the following:

Item 1201: Upon cover the options to moderate are as follows:
Approve/Unapprove—Upon approval the comment becomes available to members of the MMJ
Reply: This allows the Student to reply directly to the comment made
Quick Edit: This allows the Student to alter the contents of the comment
Edit: This allows the Student full options to alter the comment
Spam: This designates the comment as spam; the system recognizes this and disallows users from that IP or address from posting again.
Trash: This allows the Student to place the comment into the trash where it will need to be deleted permanently.

All other items on the page remain the same; top, bottom and left navigation as well as logout and contextual help.

### Other Activities

### Add Users/Edit Profile

Students may add Family/Friend members up to 25. The process is as follows:

1. Student clicks users on the left navigation bar in the administration side of the MMJ

2. Student clicks add new user

3. Student enters a user name, email and chooses the Family Friend role from the drop down box

4. A confirmation email is sent to the email address entered

5. When the new user clicks the activation link, the account is activated and the page displays the username and a randomly generated password.

6. The new user is provided a link to login and directed to change the password to something easier to remember.

From the users page the Student may also remove Family/Friend members.

### Other Activities

### Edit Profile

The Student may access their profile page by clicking on users in the left navigation bar and then selecting Your Profile. On the resulting screen the Student may change the email address, password, or how their name is displayed in the MMJ. usernames once assigned cannot be changed.

### Teacher/mentor and Family/Friend Processes

While Teacher/mentor, Mentor, and Family/Friend roles are different in scope, their role assignments and privileges are the same. Both roles can submit a post for review, upload audio, video or photos to the posts, submit comments for review and edit their profiles. The only difference is the Teacher/mentor role has access to the Teacher/mentor page, and the Family/Friend role does not.

### Front End Processes

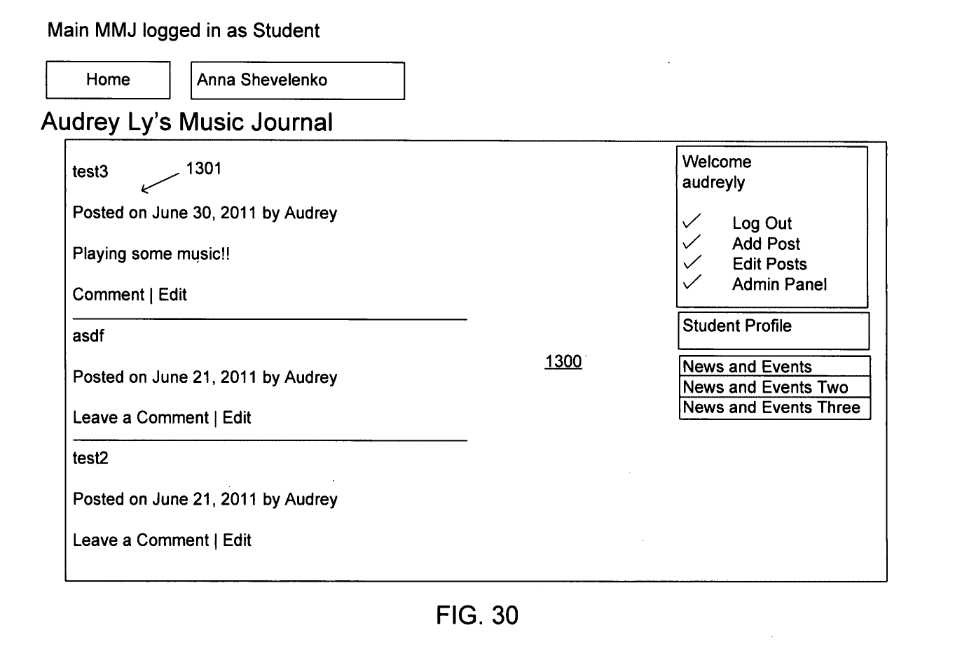

FIG. 30 shows screen 1300, which is the main MMJ student page. The main MMJ page for each student houses content the student has approved or posted. There is also a page for each teacher/mentor the student is associated with. This page houses content the student has approved and is only viewable between the student and the teacher/mentor. The sidebar navigational system changes based on user role.

### Main MMJ Logged in as Student

Any role may access this page after logging in and clicking the Home button in the backend of the MMJ in the top main navigation. Note the following:

Item 1301: All post content approved by student to appear. Each post is excerpted here. The user may click on the title of the post to view full post content. If there are comments, the number of comments is posted at the bottom—and there is also an edit link that allows the student to directly edit the post.

Item 1302: This side bar navigation allows the student immediate access to the backend of the MMJ to perform the tasks listed.

Item 1303: This house content and a picture created by the student and categorized as Student Profile and Student Profile Picture.

### Main MMJ Logged in as Teacher/mentor

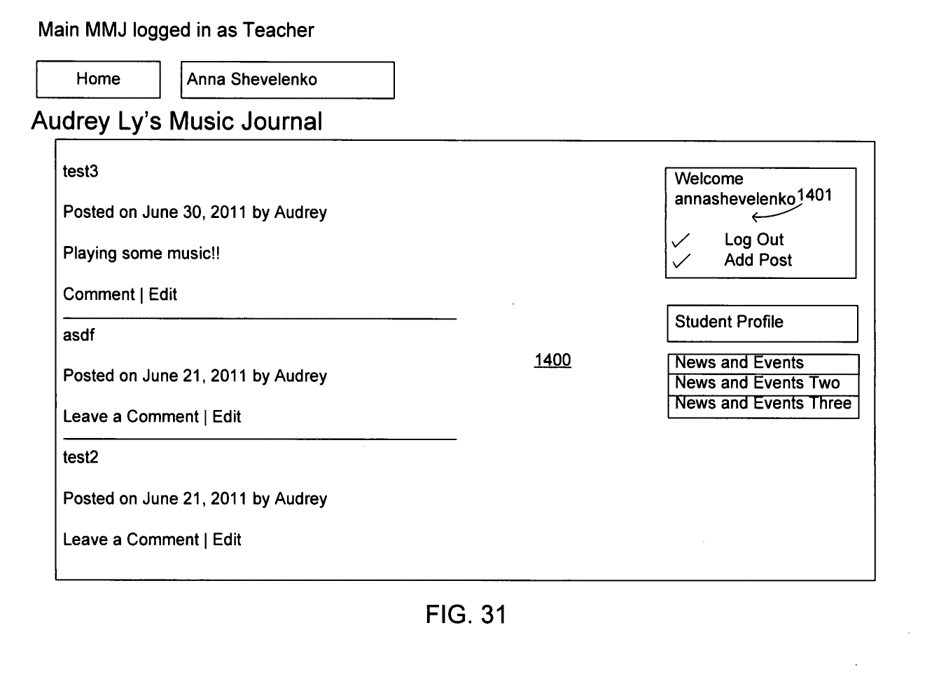

FIG. 31 shows the main MMJ teacher/mentor page 1400. Note that this screen is the same as the Student front end MMJ (FIG. 30)—the only difference is item 1401—The Teacher/mentor only has the ability to Log Out or Edit a Post.

### Main MMJ Logged in as Family/Friend

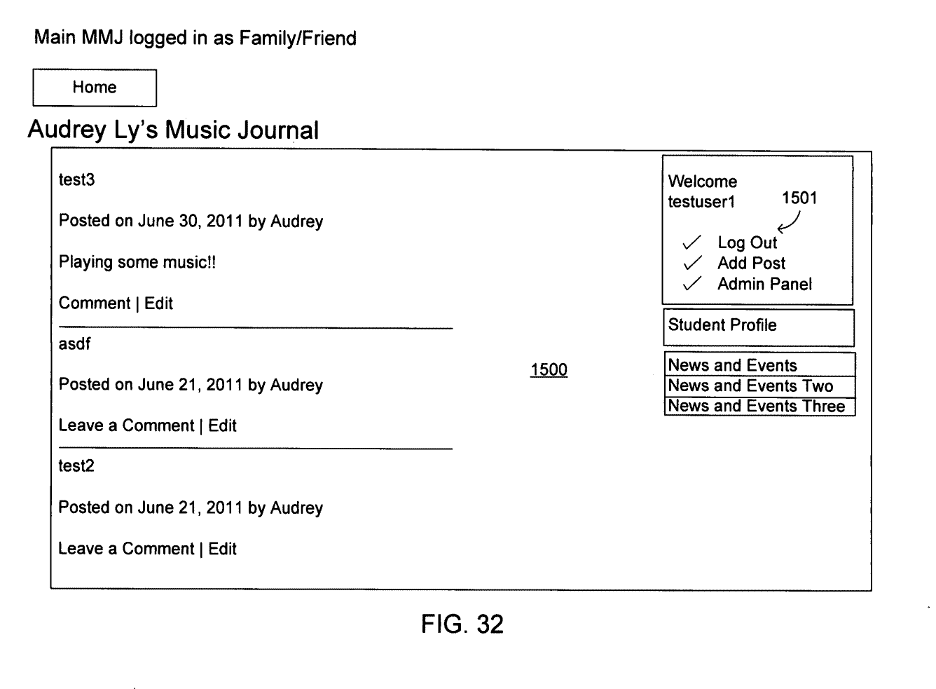

FIG. 32 shows the main MMJ family/friend page 1500. Note that this screen is similar to screens 1300 and 1400 except for the sidebar navigation (item 1501) and also the main top navigation does not have the teacher/mentor page available.

Although the above-preferred embodiments have been described with specificity, persons skilled in this art will recognize that many changes to the specific embodiments disclosed above could be made without departing from the spirit of the invention. Therefore, the attached claims and their legal equivalents should determine the scope of the invention.

What is claimed is:

1. A system permitting a studio to utilize the Internet to self-empower a plurality of students and to provide private monitoring of performance of the students by a company administrator, a plurality of mentors and a limited number of third parties selected by the students, said system comprising:
A) a company controlled server computer in communication, via the Internet, with the plurality of students, their mentors, if any, the administrator and the limited number of selected third parties, said server computer comprising:
i. software adapted to permit Internet communication among the plurality of music students, their mentors and a limited number of selected third persons,
ii. software adapted to permit input through the Internet regarding the student's performance from said limited number of selected third persons
B) a plurality of student computers in Internet communication with said server computer, said plurality of student computers; each of said student computers comprising software adapted to permit:
1. each of the plurality of students to upload to the server computer, encrypted student performances of musical works for storage in a file associated with the student,
2. each of the plurality of music students to verify registration of a limited number of computers in communication with the Internet that are to have access to the student's file and are under control of selected third parties who have agreed prevent access to members of the general public of the students performances;
C) a plurality of third party computers in Internet communication with said server computer, wherein each of said plurality of third party computers comprises:
i. software adapted to permit monitoring by the limited number of selected third parties, via the third party computers and the Internet, of student performances of musical works,
ii. software to permit transmittal to the student via the third party computers, the Internet and the server computer of responsive information based on said student performances of the musical works,
wherein the performance of any copyrighted works thereby made available to the administrator, music teachers and the selected third parties qualify as a private (not public) performance under relevant copyright laws and not an infringement of copyright.

2. The system as in claim 1 wherein the company administrator is trained in copyright law and is responsible to assuring compliance by the studio with the law.

3. The system as in claim 1 and further comprising a music teacher computer in Internet communication with said server and programmed with software adapted to permit transmitting and receiving music information related to the learning process of the music student.

4. The system as in claim 1, wherein said server computer is programmed with software adapted to produce a web site to facilitate said communication between each of said music students and the limited number of selected third parties.

5. The system as in claim 4 where the limited number of selected third parties selected by each of the plurality of students are all friends or family members of the selecting students.

6. The system as in claim 1, wherein uploaded performances of musical works comprises:
A) audio files,
B) video files, and
C) picture files.

7. The system as in claim 1, wherein uploaded performances of musical works comprises:
A) jam sessions,
B) lessons,
C) accomplishments,
D) practice sessions, and
E) recitals

8. The system as in claim 1 wherein the server is also programmed to permit access by the general public to performances of licensed copyrighted and non-copyrighted works by the students for a fee.

9. The system as in claim 8 wherein copyright licenses are obtained by the music studio.

10. The system as in claim 8 wherein copyright licenses are obtained by the student or his mentor.

11. The system as in claim 8 wherein the fee is shared between at least the owner, if any, of the copyright, the music studio and the student.

12. The system as in claim 8 wherein the fee is shared between at least the owner, if any, of the copyright, the music studio, the student and the mentor.
